(19) United States
(12) Patent Application Publication
(10) Pub. No.: US 2018/0333321 A1
(43) Pub. Date: Nov. 22, 2018

(54) Step-Up

(71) Applicant: Eugene Traynor, Delray Beach, FL (US)

(72) Inventor: Eugene Traynor, Delray Beach, FL (US)

(21) Appl. No.: 15/731,296

(22) Filed: May 20, 2017

(51) Int. Cl. A61H 3/00

(52) U.S. Cl. CPC A61H 3/00; A61H 2003/001

(57) ABSTRACT

A highly-portable step navigation assisting apparatus for attaching to just one footwear of the two footwear worn on a person during a navigation of a step change in elevation permits reduction in the amount of knee bending and fatigue of the person during the navigation of the step change in elevation. The step navigation assisting apparatus comprises a selected height platform with a platform bottom and a platform top; and a single attachment means anchored to a position within the front half of the platform and for passing over the footwear in front of the ankle for attaching the one footwear to the platform top. The step navigation assisting apparatus meets a long-felt need by disabled and elderly persons with a knee disability or other medical condition who need to navigate a step with both hands free

### BACKGROUND OF THE INVENTION

The field of the present invention concerns portable platforms for a disabled person to use so they can safely and easily walk one step at a time either up or down a step or plurality of steps such as stairs. Stairs between floors in homes and buildings, in public building entrances, in subway entrances, and bus door entryways can be painful for a disabled person to navigate.

The disabled person may be elderly and weak, and they might have a problem coordinating the moving of their legs. The disabled person may be young and suffer a movement disorder. The disabled person may be recovering from a stroke. It may be stressful for them to bend their knees because they suffer knee-joint damage and pain. They may develop muscle fatigue when they use their legs to climb or descend a stair step. They might have a problem with their balance which might require that they use both hands at the same time to hold onto a stair railing for safety to maintain their balance and to more easily advance themselves up or down stairs so that they do not stumble or fall or becoming exhausted. During stair navigating a disabled person might suffer a sudden loss of imbalance or become dizzy.

In the prior art there are non-electrical devices which can be held and moved by hand to help a disabled person to go up and down stairs. One example is the Schaaf invention (1981) U.S. Pat. No. 4,274,430 which is a walking cane apparatus for use walking up and down stairs. The device has a support structure for a foot to stand on which is hinged to the walking cane. Schaaf's foot supporting platform surface has two fixed-height legs. One problem is that the legs of Schaaf's apparatus may hook onto a stair edge while the device is being moved from one stair to the next and this might cause a disabled person to stumble on the stairs or fall. Another problem is that the cane shaft is free to rotate and this can cause a foot to twist into an off-balance angle on the platform and cause a disabled person to twist their ankle. Thus the Schaaf walking cane apparatus is not a safe device nor is it easy to use by a disabled person during stair climbing or stair descending. Also the Schaaf apparatus needs to be moved from stair to stair by the disabled person. This means the disabled person is expected to hold a cane handle of the apparatus with one hand and this leaves just one hand free for the disabled person to hold onto a stair railing for support and to maintain their balance. The Schaaf apparatus also suffers from being heavy and its hinged foot platform must be swung from its side position attached to cane shaft down to a flat position to use. During use on stairs, the foot position on the platform must be controlled by a downward pressure by the foot upon the platform. If not, both feet have to stand on a stair. Thus use of Schaaf's invention is mentally taxing and requires a disabled person to practice making complicated decisions of body coordination. If the disabled person makes a mistake and becomes imbalanced, then the apparatus will be dropped or they could fall.

Another prior art example, similar to Schaaf, is the Heifetz invention (1992) U.S. Pat. No. 5,131,494. Heifetz invention is a box for climbing stairs. Unlike Schaaf, Heifetz invention is without legs but still has a walking cane attached to the side of the box. The box has a fixed height of about one-half step, is about as wide as a stair step width, and has a long length so that two feet would stand on the box at the same time. Thus it appears that the device will be heavy. The Heifetz device must be manually held onto by its straight walking cane when its box needs to be lifted or lowered from step to step. Given that the device is to be used by a disabled person who according to Heifetz is “suffering from atrophy, back and leg problems”, the Heifetz invention appears to be poorly designed and of low utility. It is depicted in Heifetz FIG. 2, that the disabled person is expected to use only one free hand to pull themselves and to balance themselves as they move from step to step. A disabled person needs both hands free.

Another prior art example is the Wallum invention (1994) U.S. Pat. No. 5,318,057 which is a manually-movable box with its walking cane in the middle of device's box. Use of the Wallum device by a disabled person creates difficulties similar to the Heitfetz invention.

More complicated than Wallum, and just as problematic is the device of Tschirhart (1999) U.S. Pat. No. 5,941,262 which has a centralized walking cane attached to an adjustable-height walking platform. Its centralized walking cane pivots and its shaft has two 90 degree bends to change how the cumbersome walking platform-cane is dragged up over stairs.

An even more complicated device is the Karasin invention (2009) U.S. Pat. No. 7,509,966 which is a step assist device having a base with an extendable and retractable platform. There is an actuator manually operably-engaged with a linkage connected to the platform, the linkage configured to extend and retract the platform upon operation of the actuator. The two part handle actuator cane portion and the rest of the device has to be pulled to lift the stepping platform from stair to stair. The Karasin device does not permit a disabled person to have more than one hand to hold onto a stair railing as they navigate a step or stairs.

The step-ramp invention of Hart (2006) US Published Patent Application No. 2006/0243522 A1 is a foldable, step stool that is multi-paneled, hinged, light, and transportable. It is a ramp-like stepping device with handles on each side of the panels instead of an attached walking cane. This stepping device is for assisting people and animals as they enter and exit vehicles and buildings. The user may place or have a caregiver set down the device on the ground in front of a door of a car or house. Preferred dimensions of the stepping device are 18 to 48 inches. The Hart device exceeds a normal stair tread width dimension and is clearly not intended to be used to safely climb or descend multiple stair steps.

Another prior art step stool is the FirstStreetonline Company (2017) product which is at least 12 inches wide by 24 inches long in platform area. The platform of the FirstStreetonline half-step is much larger than a stair step width and cannot rest on a stair step without falling off. The step stool has spaces between its four corner legs instead of handles for manually picking it up and moving it. FirstStreetonline also sells a Porta Accessibility Step which folds for travel or storage. This company indicates that their products are designed for use at the front and back doors, getting in or out of cars and as step stools for trucks, RV's and boats.

The StairAide Company (2017) sells a non-portable, wooden block which is to be permanently screwed into the tread of each stair of a stairway. Each box would be screwed to one wooden stair step for example, along one side of a staircase. An average flight of stairs will need 19 StairAide wooden block boxes mounted permanently to the stairs.

The prior art fails to teach a stair-climbing device which leaves both hands of the disabled person free at all times during step or stairs navigation up or down each step. It is more safe for a disabled person to hold on to a hand railing with both hands so if they become imbalanced so they will not fall. Having both hand free helps them control their movements up or down over a stair step and importantly they will feel safer, less frustrated and in control. The device assisting their stair navigation should not have a protruding part to hang up on a step. The device should not have to be manually moved as the disabled person moves from step to step. The device needs to be light-weight. The device need to be non-metallic so it is not a problem passing through metal detectors. The device needs to be small for convenient handling and packing away on a trip. On day trips the device should be portable, and quickly reversibly-attachable anywhere for use in any home and any public place with a step or stairs.

### BRIEF SUMMARY OF THE INVENTION

The invention embodiments can be called Step-Up inventions. The Step-Up invention is designed to help meet the needs of a person who may be disabled but can walk, and whatever the cause of their disability the person wishes to have a manageable, independent, happy, and safe lifestyle. The person who can benefit from using the present invention in its various embodiments is a person who has a difficulty or a disability to navigate an ordinary step in their home or a typical step they encounter in public places that that they need to routinely navigate. The Step-Up invention is particularly useful for a person who finds that a navigation of a step may be impossible or may result in the person feeling fatigued, pain, nausea from a sense of imbalance, and unsafe with a risk of stumbling or falling on the step. The difficulty of the person to navigate a step change in elevation may be due to their health condition which may include having a muscle injury, joint injury, arthritis, healing from leg surgery, muscle weakness, a lack of stamina, being easily fatigued, asthma, a respiratory dysfunction such as lung cancer, being elderly, lacking joint flexibility/muscle stiffness, knee damage, pain bending a knee, a central nervous system disease, a drug side-effect, a peripheral nervous system disease, a problem with their sense or ability to maintain their balance. The Step-Up invention addresses the needs of a disabled person to explore the world and its step changes in elevation. By using the invention, a disabled person can reduce the amount of knee bending and the amount of fatigue that the disabled person suffers navigating a step change in elevation.

In some embodiments, the present invention is a platform for reversibly attaching to a footwear worn by a person for assisting the person ascend and descend a step or a flight of stairs with less effort by reducing the amount of physical lift that the person has to expend during each movement of a leg in the process of navigating each step change in elevation. The invention also can reduce how much the person needs to bend their knees during navigation of a step change in elevation. The invention can also reduce how much the person needs to extend one of their legs forward to get their foot to go up from a step horizontal surface and over a step to a higher horizontal surface or to lower step horizontal surfaces. The invention is particularly useful for assisting a disabled person who has a painful injured knee or a painful arthritic knee where the more they bend their knee, the more pain they feel during a navigation of a step. The invention can make step navigation less stressful. Some disabled persons fatigue while trying to navigate a tall step. Some embodiments of the present invention can be custom designed so as to make a navigation of a high step change in elevation by a person going on to a bus entryway from street level or exiting the bus to street level feel safer, less painful, and more possible.

One embodiment of the present invention is a step navigation assisting apparatus for attaching to just one of the two footwear worn on a person during a navigation of a step change in elevation to reduce knee bending and fatigue of the person during the navigation of the step change in elevation, the step navigation assisting apparatus comprising: a platform with a platform bottom; an attachment means; and a platform top with a top surface for placing the one footwear of the two footwear worn by the person,
wherein the platform is for attaching to the one footwear of the two footwear worn by the person by the attachment means from the platform when the one footwear of the two footwear worn by the person is placed on the top surface of the platform top so that the platform and the one footwear can move attached together during the navigation of the step change in the elevation and both hands of the person can be free for holding onto a safety hand railing,
wherein only one attachment means is used,
wherein the one attachment means is for passing over a top section of the footwear worn by the person so as to hold the footwear securely,
wherein the one attachment means is used for holding down a footwear portion in front of the ankle of the person,
wherein the bottom surface on the platform bottom is for contacting each step horizontal surface during the navigation of the step change in the elevation by the person,
wherein the top surface of the platform top is at a height above the bottom surface of the platform bottom,
wherein the height of the top surface of the platform top above the bottom surface of the platform bottom is selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the platform attached to the one footwear of the two footwear worn on the person is for standing on by the person during navigation of each horizontal surface of the step change in elevation,
wherein the platform is for keeping the one footwear of the two footwear worn on the person at the height of the top surface of the platform top above the bottom surface of the platform bottom during the navigation of the step change in elevation so as to reduce the amount of knee bending and the amount of fatigue of the person during the navigation of the step change in elevation, and
wherein the attachment of the platform to the one footwear of the two footwear on the person is detachable.

Another embodiment of the present invention is a step navigation assisting apparatus for attaching to just one of the two footwear worn on a person during a navigation of a step change in elevation to reduce amount of knee bending and amount of fatigue of the person during the navigation of the step change in elevation, the step navigation assisting apparatus comprising:
a platform with a platform bottom; an attachment means; and a platform top with a top surface for placing the one footwear of the two footwear worn by the person,
wherein the platform is for attaching to the one footwear of the two footwear worn by the person by the attachment means from the platform when the one footwear of the two footwear worn by the person is placed on the top surface of the platform top so that the platform and the one footwear can move attached together during the navigation of the step change in the elevation and both hands of the person can be free for holding onto a safety hand railing,
wherein only one attachment means is used,
wherein the one attachment means is for passing over a top section of the footwear worn by the person so as to hold the footwear securely,
wherein the one attachment means is used for holding down a footwear portion in front of the ankle of the person,
wherein the one attachment means is for anchoring anchored at a position within a front half of a platform length,
wherein the bottom surface on the platform bottom is for contacting each step horizontal surface during the navigation of the step change in the elevation by the person,
wherein the top surface of the platform top is at a height above the bottom surface of the platform bottom which is about one half of the distance of the step change in the elevation to be navigated by the person, the height of the top surface of the platform top above the bottom surface of the platform bottom selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches, wherein the platform attached to the one footwear of the two footwear worn on the person is for standing on by the person during navigation of each horizontal surface of the step change in elevation, wherein the platform is for keeping the one footwear of the two footwear worn on the person at the height of the top surface of the platform top above the bottom surface of the platform bottom during the navigation of the step change in elevation so as to reduce the amount of knee bending and the amount of fatigue of the person during the navigation of the step change in elevation, and wherein the attachment of the platform to the one footwear of the two footwear on the person is detachable.

A preferred embodiment of the present invention is a step navigation assisting apparatus for attaching to just one of the two footwear worn on a person during a navigation of a step change in elevation to reduce amount of knee bending and amount of fatigue of the person during the navigation of the step change in elevation, the step navigation assisting apparatus comprising: a platform with a rectangular platform bottom; an elastic Velcro® mini-hooks and fiber mat connector system strap attachment means; and a rectangular platform top with a top surface for placing the one footwear of the two footwear worn by the person,
wherein the platform is for attaching to the one footwear of the two footwear worn by the person by the attachment means from the platform when the one footwear of the two footwear worn by the person is placed on the top surface of the platform top so that the platform and the one footwear can move attached together during the navigation of the step change in the elevation and both hands of the person can be free for holding onto a safety hand railing,
wherein only one attachment means is used, wherein the one attachment means is for passing over a top section of the footwear worn by the person so as to hold the footwear securely,
wherein the one attachment means is used for holding down a footwear portion in front of the ankle of the person,
wherein the one attachment means is for anchoring anchored at a position within a front half of a platform length,
wherein the top surface of the platform top is at a height above the bottom surface of the platform bottom which is about one half of the distance of the step change in the elevation to be navigated by the person, the height of the top surface of the platform top above the bottom surface of the platform bottom selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the platform attached to the one footwear of the two footwear worn on the person is for standing on by the person during navigation of each horizontal surface of the step change in elevation;
wherein the platform is for keeping the one footwear of the two footwear worn on the person at the height of the top surface of the platform top above the bottom surface of the platform bottom during the navigation of the step change in elevation so as to reduce the amount of knee bending and the amount of fatigue of the person during the navigation of the step change in elevation, and
wherein the attachment of the platform to the one footwear of the two footwear on the person is detachable by the person.

Another embodiment of the present invention is an adjustable height step navigation assisting apparatus for attaching to just one of the two footwear worn on a person during a navigation of a step change in elevation to reduce amount of knee bending and amount of fatigue of the person during the navigation of the step change in elevation, the adjustable height step navigation assisting apparatus comprising:
an adjustable height platform with a platform bottom layer; an attachment means; and a platform top layer with a top surface for placing the one footwear of the two footwear worn by the person,
wherein the adjustable height platform is for attaching to the one footwear of the two footwear worn by the person by the attachment means from the adjustable height platform when the one footwear of the two footwear worn by the person is placed on the top surface of the platform top layer so that the adjustable height platform and the one footwear can move attached together during the navigation of the step change in the elevation and both hands of the person can be free for holding onto a safety hand railing,
wherein only one attachment means is used,
wherein the one attachment means is for passing over a top section of the footwear worn by the person so as to hold the footwear securely,
wherein the one attachment means is used for holding down a footwear portion in front of the ankle of the person,
wherein the one attachment means is for anchoring anchored at a position within a front half of a platform length,
wherein the adjustable height platform has a bottom surface on the platform bottom layer, the bottom surface for contacting each step horizontal surface during the navigation of the step change in the elevation by the person,
wherein the top surface of the platform top layer is at a height above the bottom surface of the platform bottom layer,
wherein the platform top layer has a bottom area for connecting by a Velcro® mini-hooks and fiber mat strap connection system to a top area of the platform bottom layer,
wherein the Velcro® mini-hooks and fiber mat strap connection system between the bottom area of the platform top layer and the top area of the platform bottom layer is for disconnecting when the person decides the height of the top surface of the platform top layer above the bottom surface of the platform bottom layer is to be changed to a new height,
wherein the bottom platform layer in the adjustable height platform can be replaced with a different height platform bottom layer when the height of the top surface of the platform top layer above the bottom surface of the platform bottom layer is to be changed to the new height, and optionally the top platform layer in the adjustable height platform can be replaced with another height platform top layer when the height of the top surface of the platform top layer above the bottom surface of the platform bottom layer is to be changed to the new height,
wherein the new height of the top surface of the platform top layer above the bottom surface of the platform bottom layer can be selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the adjustable height platform attached to the one footwear of the two footwear worn on the person is for standing on by the person during navigation of each horizontal surface of the step change in elevation,
wherein the adjustable height platform is for keeping the one footwear of the two footwear worn on the person at the height of the top surface of the platform top above the bottom surface of the platform bottom during the navigation of the step change in elevation so as to reduce the amount of knee bending and the amount of fatigue of the person during the navigation of the step change in elevation, and
wherein the attachment of the platform to the one footwear of the two footwear on the person is detachable by the person.

In related embodiments of the invention the step navigation assisting apparatus has an attachment means which comprises an elastic strap. In related embodiments of the invention, the step navigation assisting apparatus has an attachment means which comprises an elastic strap with a Velcro® mini-hooks and fiber mat connector system. The strap can have a portion which is elastic and a portion which is not elastic.

In related embodiments of the invention, the step navigation assisting apparatus has an a platform top perimeter which is selected from the group consisting of a rectangular platform top perimeter, a rounded platform top perimeter, a polygonal platform top perimeter, and any combination thereof. The step navigation assisting apparatus may be made with a material selected from the group consisting of a lightweight foam rubber, a plastic, a dense foamed plastic, an elastic porous material, a foam core with a rubber or plastic coating as a shell on one or more sides, a polymeric foam, a urethane foam, a closed cell foam such as Aqua Cell® a closed cell polyvinyl chloride foam, a polyurethane foam, a polystyrene, a sculpture foam, a balsa wood, a woven fabric around a block of a stiff material, and any combination thereof.

In many embodiments of the invention, the step navigation assisting apparatus is especially useful to navigate a step change in elevation selected from the group consisting of a street curb, stairs between floors in a house, stairs between floors in an apartment, the stairs between floors in a building, a step up to a bus from a road surface, a step down from the bus to a road surface, cellar stairs, the stairs going down from a sidewalk elevation to a subway platform, stairs from the subway platform to the street elevation, the step up from a ground surface to a train entryway, the step down from a train to the ground surface, fire escape stairs in a building going down to the street, stairs on a ship, ascending or descending steps in a park or a patio, a step stool step, a step ladder steps, and stairs in a sports stadium to seats.

In a preferred embodiment of the invention, the step navigation assisting apparatus has a platform which is a rectangular platform of a plastic foam and weighing between about 6 ounces to about 16 ounces, wherein the platform has a width of between about 4 inches to about 7 inches and the platform has a length of between about 6.5 to about 10.5 inches, wherein the platform has a height measured from the top surface of the platform to the bottom surface of the platform and the height is between about 2.5 to about 4.5 inches, wherein the attachment means comprises an elastic strap with a strap length of about 14 to about 24 inches long with a strap width of between about 0.25 inch to about 5 inches wide and a strap thickness of between about 0.02 inches to about 0.75 inches thick, and the elastic strap has a fiber mat end portion and a Velcro® mini-hooks end portion.

In yet another embodiment of the invention, the step navigation assisting apparatus has a height of the top surface of the platform top above the bottom surface of the platform bottom which is between about 2.5 inches to about 4.5 inches, and the attachment means comprises an elastic strap with a fiber mat end portion and a Velcro® mini-hooks portion.

Embodiments of the present invention are useful for reducing the amount of knee bending and amount of fatigue of the person during the navigation of the step change in elevation and are preferably lightweight and easy to put on and to take off as needed.

### BRIEF DESCRIPTION OF THE SEVERAL DRAWINGS

Examples of some embodiments of the present invention are depicted schematically in drawings: FIG. 1-FIG. 6 (FIGS. 1-6). Many embodiments of the invention are contemplated and the invention is not limited to the schematic depictions of the embodiments in the drawings.

FIG. 1 depicts an invention embodiment which comprises a platform 102 with a strap attachable means 107 which passes transversely through platform 102 from one side wall 104 to other platform side wall 112. Attachment means 107 has end portions 106 and 113 can be a Velcro® mini-hooks and fiber mat connector system with mini-hooks front wall 512 on strap section 106 reversibly connectable to fiber mat end portion 113. Platform 102 top surface is for attaching one footwear of the two footwear of disabled person so that the one footwear is pointing towards platform front end 110.

FIG. 2 depicts an apparatus embodiment of the invention in a schematic side view. Apparatus comprises a platform 204 having three horizontal transverse holes 206, a platform bottom 205, and a transverse slit hole 208, and an attachment means with attachment means end portions connected together and attaching footwear to the platform top. Attachment means end portion 207 passes through the transverse slit hole 208 with end portions of 207 and 211 connected together for attaching footwear 201 to the platform top 203 as depicted.

FIG. 3 depicts another embodiment of the present which comprises a platform 304 with an attachable means which is a Velcro® mini-hooks and fiber mat strap connector system with mini-hooks end portion 303 and fiber mat end portion 307 depicted connected together. Platform 304 top has a footwear pattern 308 pointed to platform front end 301 to show where a footwear of a person is to be placed for attachment to the platform 304.

FIG. 4 depicts in a top view, an embodiment of the invention with label 210 “KOOL STEP” at front end 401 of platform 404 top. Platform 404 has a chiseled margin 402, a platform bottom 405, and side walls 408. Footwear can be positioned pointing to front end 401 and attached using the depicted strap 409 attachable means which has a Velcro® mini-hooks strap end portion 406 and a Velcro® fiber mat strap end portion 407 for quickly reversibly attaching just one of the two footwear of disabled person to the platform top.

FIG. 5 depicts another embodiment of the invention comprising: two juxtaposed platform layers 505 and 510 connectable between surfaces 509 and 506 by a Velcro® mini-hooks and fiber mat connector system wherein for example, surface 509 might have the Velcro® mini-hooks while surface 506 might have the Velcro® fiber mat. Depicted also with platform layer 505 is an attachment means 502 with attachment means connectable end portions 501 and 508 on platform layer 505 top 503 for attaching one footwear of a disabled person to platform top 503.

FIG. 6 depicts silhouette side views of persons 601 and 611 navigating steps 607 and 615 on separate stairs 605 and 614. One footwear of the two footwear on person 601 is attached by attachable means 606 to invention embodiment comprising: a platform 604; with attachable means 606. Platform 604 height is one half of step height 607. All FIG. 6 steps are same height. The amount of needed bending of knee 610 of person 601 using invention embodiment 604 is much less than the amount of bending of knee 618 of person 611 not using present invention.

FIG. 7 provides top view generic depictions of eight example platform shapes for the invention: a rectangular platform shape 701; a chiseled front, six-sided platform shape 702; a convex front with concave back platform shape 703; a flat front with pointed back five sided platform shape 704; an oval platform shape 705; a truncated front cone platform shape 706; a 90 degree back corner oval platform shape 707; and pointed front and bad end hexagonal platform shape 708. Note that for some embodiments of the invention, the platform top and platform bottom can have the same shape. Also note that the front end each platform shape points to right side of FIG. 7 and that the attachment means of the invention is not depicted.

### DETAILED DESCRIPTION OF THE INVENTION

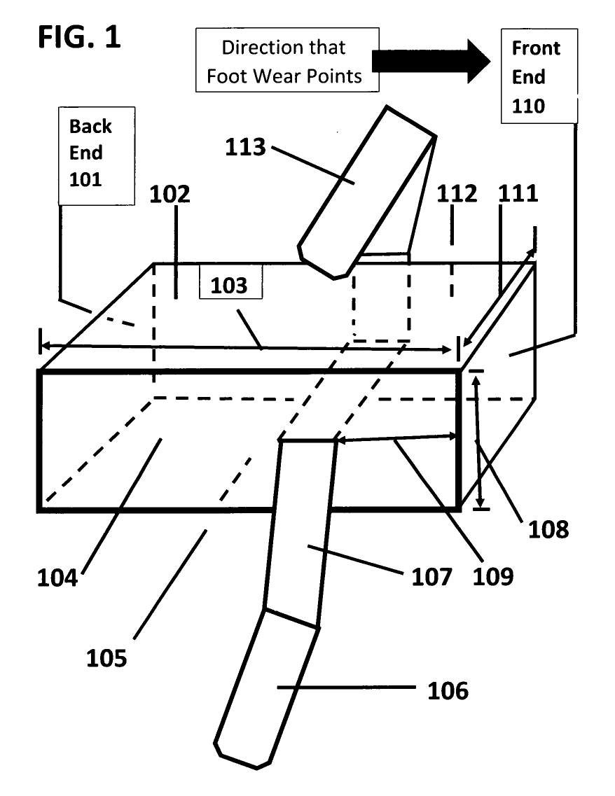

FIG. 1 is a schematic depiction of one embodiment of the invention which is an apparatus which may comprise a rectangular platform 102 with width 111, of length 103, and having a height 108 which is the distance from platform top 102 to platform bottom; and an attachment means such as an elastic strap 107 with Velcro® mini-hooks end portion 106 and fiber mat end portion 113. The platform depicted in FIG. 1 has a front end 110 and a back end 101 with side walls. Just one of the two footwear worn by the person using the present invention is placed down on platform 102 top so as to point footwear to platform front end 110. The attachment means of the platform 102 which is depicted in FIG. 1 is a single long thin elastic strap 107 which passes horizontally and transversely through a slit across the width of the platform 102 from side wall 104 to side wall 112 and the platform 102 has the slit hole a distance 109 from platform front end 110. With reference to FIG. 1 depiction as a guide, in contemplated embodiments of the invention, the distance 109 relative to the platform length 103 is preferably between about 20 percent to about 40 percent of the length 103; and more preferably between about 25 percent to about 35 percent of length 103 of the platform 102. Note also that height 108 is also distance 108 from platform 102 top to platform bottom 105.

Some platform embodiments of the invention can have a distance 103 in inches which is between about 7 inches to about 12 inches long; can have a width 111 which is between about 3.5 inches to about 7 inches wide; and a height 108, wherein height 108 is synonymous with saying platform thickness 108, the height 108 of between about 2.5 inches to about 6 inches tall or thick. If desired, the attachment means might be glued to the platform. In general, the attachment means may be fixed to the platform using glue, sewing thread, a fastener, or other anchoring means such as a Velcro® mini-hooks and fiber mat connector system, a staple, a button and button hole fastener to attach the attachment means anywhere to the platform.

Anchoring of the elastic strap 107 which passes horizontally and transversely through a slit hole makes stretching the elastic strap 107 simple, and the manual connecting of a Velcro® mini-hooks end portion 106 to a Velcro® fiber mat end portion 113 a relatively easy task for a person after the one footwear worn by the person is situated on the platform 102 top. To attach the attachment means to the platform, the platform may be sliced horizontally and transversely to create an access path for the attachment means and then the slice may be closed for example using glue. When the invention embodiment has an attachment means which is a Velcro® mini-hooks and fiber mat connector system, then the end portions of the strap may be connected together by pressing them together. For example, the strap could be a thin elastic plastic or nylon weave strap with end portions which are a Velcro® mini-hooks end portion 106 and Velcro® a fiber mat end portion 113. End portions of the strap attachment means are connected together by pressing them together over top part of the one of the two footwear worn by the person so as to attach the one footwear to the platform 102 top from which the attachment means in some embodiments of the invention originates and thereto is attached.

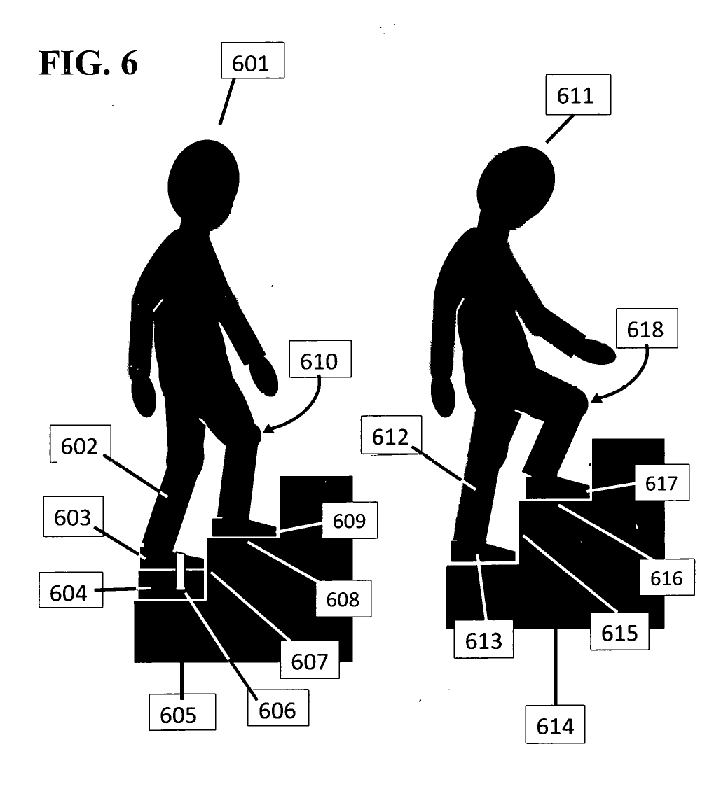

One embodiment of the present invention is a step navigation assisting apparatus for attaching to just one of the two footwear worn on a person during a navigation of a step change in elevation to reduce knee bending and fatigue of the person during the navigation of the step change in elevation, the step navigation assisting apparatus comprising:
a platform 102 with a platform bottom 105; an attachment means 107 with end portions 106 and 113; and a platform 102 top with a top surface for placing the one footwear of the two footwear worn by the person,
wherein the platform 102 is for attaching to the one footwear of the two footwear worn by the person by the attachment means 107 with end portions 106 and 113 from the platform 102 when the one footwear of the two footwear worn by the person is placed on the platform top so that the platform and the one footwear can move attached together during the navigation of the step change in the elevation and both hands of the person can be free for holding onto a safety hand railing,
wherein the platform bottom 105 is for contacting each step horizontal surface during the navigation of the step change in the elevation by the person,
wherein the platform 102 top is at a height 108 above the platform bottom 105,
wherein the height 108 of the platform 102 top above the platform bottom 105 is selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the platform 102 attached to one of the two footwear worn on the person is for standing on by the person during navigation of each horizontal surface of the step change in elevation;
wherein the platform 102 is for keeping the one footwear of the two footwear worn on the person at the height 108 above the bottom 105 during the navigation of the step change in elevation so as to reduce the amount of knee bending and the amount of fatigue of the person during the navigation of the step change in elevation, and
wherein the attachment of the platform 102 to the one footwear of the two footwear on the person is detachable by the person. The person can disconnect the end portions 106 and 113 of attachment means 107 end portions from around the footwear. Note that FIG. 6 schematically depicts use of an invention embodiment related to the embodiment schematic in FIG. 1. Also, note that left side of FIG. 6 in a highly schematic form, depicts an example step horizontal surface 608 during a navigation of the step change in the elevation 607 by a person 601 with an invention embodiment 604 which is similar to the embodiment depicted in FIG. 1. Also note that FIG. 6 points out the manner by which the present invention allows a person such as a disabled person to reduce the amount that their knees must bend during a navigation of a step change in elevation.

One embodiment of the present invention is a step navigation assisting apparatus for attaching to just one of the two footwear worn on a person during a navigation of a step change in elevation to reduce amount of knee bending and amount of fatigue of the person during the navigation of the step change in elevation, the step navigation assisting apparatus comprising:
a platform 102 with a platform bottom 105 ; an attachment means 107 with end portions 106 and 113; and a platform 102 top for placing the one footwear of the two footwear worn by the person,
wherein the platform 102 is for attaching to the one footwear of the two footwear worn by the person by the attachment means 107 with end portions 106 and 113 from the platform 102 when the one footwear of the two footwear worn by the person is placed on the top surface of the platform 102 top so that the platform 102 and the one footwear can move attached together during the navigation of the step change in the elevation and both hands of the person can be free for holding onto a safety hand railing,
wherein the platform bottom 105 is for contacting each step horizontal surface during the navigation of the step change in the elevation by the person,
wherein the platform 102 top is at a height above the platform bottom 105 at a height 108 which is about one half of the distance of the step change in the elevation to be navigated by the person, the height 108 of the platform 102 top above the platform bottom 105 is selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the platform 102 attached to the one footwear of the two footwear worn on the person is for standing on by the person during navigation of each horizontal surface of the step change in elevation,
wherein the platform 104 is for keeping the one footwear of the two footwear worn on the person at the height 108 of the on platform 102 top above platform bottom 105 during the navigation of the step change in elevation so as to reduce the amount of knee bending and the amount of fatigue of the person during the navigation of the step change in elevation, and
wherein the attachment of the platform 102 to the one footwear of the two footwear on the person is detachable by the person. The one foot wear can be detached by disconnecting the attachment means 107 end portions 106 and 113 from around the footwear. Note that FIG. 6 schematically depicts use of an invention embodiment related to the embodiment schematic in FIG. 1. Also, note that left side of FIG. 6 in a highly schematic form, depicts an example step horizontal surface 608 during a navigation of the step change in the elevation 607 by a person 601 with an invention embodiment of the invention 604 which is similar to the embodiment depicted in FIG. 1. The Specification also points out the manner by which the present invention allows a person such as a disabled person to reduce the amount that their knees must bend during a navigation of a step change in elevation when the platform 102 top is at a height above the bottom surface of the platform bottom 105 that is about one half of the distance of the step change in the elevation to be navigated by the person.

One embodiment of the present invention is a step navigation assisting apparatus for attaching to just one of the two footwear worn on a person during a navigation of a step change in elevation to reduce amount of knee bending and amount of fatigue of the person during the navigation of the step change in elevation, the step navigation assisting apparatus comprising:
a platform 102 with a rectangular platform bottom 105; an elastic Velcro® strap attachment means 107 with Velcro® mini-hooks end portion 106 and a Velcro® fiber mat end portion 113; and a rectangular platform top for placing the one footwear of the two footwear worn by the person,
wherein the platform 102 is for attaching to the one footwear of the two footwear worn by the person by the Velcro® strap attachment means 107 with Velcro® mini-hooks end portions 106 and a Velcro® fiber mat end portion 113 from the rectangular platform 102 when the one footwear of the two footwear worn by the person is placed on the platform 102 top so that the platform 102 and the one footwear can move attached together during the navigation of the step change in the elevation and both hands of the person can be free for holding onto a safety hand railing,
wherein the bottom surface on the platform bottom 105 is for contacting each step horizontal surface during the navigation of the step change in the elevation by the person,
wherein the platform 102 top is at a height above the bottom surface of the platform bottom 105 that is at a height 108 which is about one half of the distance of the step change in the elevation to be navigated by the person,
wherein the height 108 of the platform 102 top above the platform bottom 105 is selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the platform top 102 attached to the one footwear of the two footwear worn on the person is for standing on by the person during navigation of each horizontal surface of the step change in elevation,
wherein the platform 102 is for keeping the one footwear of the two footwear worn on the person at the height 108 of the platform 102 top above the platform bottom 105 during the navigation of the step change in elevation so as to reduce the amount of knee bending and the amount of fatigue of the person during the navigation of the step change in elevation, and
wherein the attachment of the platform 102 to the one footwear of the two footwear on the person is detachable by the person. The one footwear of the two footwear on the person is detachable by disconnecting the Velcro® strap attachment means 107 with Velcro® mini-hooks end portions 106 and the Velcro® fiber mat end portion 113 from around the footwear. Note that FIG. 6 schematically depicts use of an invention embodiment related to the embodiment schematic in FIG. 1. Also, note that left side of FIG. 6 in a highly schematic form, depicts an example step horizontal surface 608 during a navigation of the step change in the elevation 607 by a person 601 with an invention embodiment of the invention 604 which is similar to the embodiment depicted in FIG. 1. The specification also points out the manner by which the present invention allows a person such as a disabled person to reduce the amount that their knees must bend during a navigation of a step change in elevation when the top surface of the platform 102 top is at a height above the platform bottom 105 which is about one half of the distance of the step change in the elevation to be navigated by the person.

Another embodiment of the present invention is a step navigation assisting apparatus for attaching to just one of the two footwear worn on a person during a navigation of a step change in elevation to reduce amount of knee bending and amount of fatigue of the person during the navigation of the step change in elevation, the step navigation assisting apparatus comprising:
a platform 102 with a platform bottom 105; an elastic Velcro® strap attachment means 107 with Velcro® mini-hooks end portion 106 and a Velcro® fiber mat end portion 113; and a platform 102 top for placing the one footwear of the two footwear worn by the person,
wherein the platform 102 is for attaching to the one footwear of the two footwear worn by the person by the Velcro® strap attachment means 107 with Velcro® mini-hooks end portions 106 and a Velcro® fiber mat end portion 113 from the rectangular platform 102 when the one footwear of the two footwear worn by the person is placed on the platform 102 top so that the platform 102 and the one footwear can move attached together during the navigation of the step change in the elevation and both hands of the person can be free for holding onto a safety hand railing,
wherein the platform bottom 105 is for contacting each step horizontal surface during the navigation of the step change in the elevation by the person,
wherein the platform 102 attached to the one footwear of the two footwear worn on the person is for standing on by the person during navigation of each horizontal surface of the step change in elevation,
wherein the height 108 of the platform 102 top above the platform bottom 105 is about one half of the distance of the step change in the elevation to be navigated by the person,
wherein the platform 102 is for keeping the one footwear of the two footwear worn on the person at the height 108 of the top surface of the platform 102 top above the platform bottom 105 during the navigation of the step change in elevation so as to reduce the amount of knee bending and the amount of fatigue of the person during the navigation of the step change in elevation, and
wherein the attachment of the platform 102 to the one footwear of the two footwear on the person is detachable by the person. The one footwear of the two footwear on the person is detachable by disconnecting the Velcro® strap attachment means 107 with Velcro® mini-hooks end portions 106 and the Velcro® fiber mat end portion 113 from around the footwear. Note that FIG. 6 schematically depicts use of an invention embodiment related to the embodiment schematic in FIG. 1. Also, note that left side of FIG. 6 in a highly schematic form, depicts an example step horizontal surface 608 during a navigation of the step change in the elevation 607 by a person 601 with an invention embodiment of the invention 604 which is similar to the embodiment depicted in FIG. 1. The specification also points out the manner by which the present invention allows a person such as a disabled person to reduce the amount that their knees must bend during a navigation of a step change in elevation when the platform 102 top is at a height above the platform bottom 105 which is about one half of the distance of the step change in the elevation to be navigated by the person.

A preferred embodiment of the present invention is a step navigation assisting apparatus for attaching to just one of the two footwear worn on a person during a navigation of a step change in elevation to reduce knee bending and fatigue of the person during the navigation of the step change in elevation, the step navigation assisting apparatus comprising:
a rectangular platform 102 with a platform bottom 105; an elastic Velcro® mini hooks and fiber mat strap attachment means 107 with Velcro® mini hooks end portion 106 and Velcro® fiber mat end portion 113; and a platform 102 top for placing the one footwear of the two footwear worn by the person,
wherein the platform 102 is for attaching to the one footwear of the two footwear worn by the person by the elastic Velcro® mini hooks and fiber mat strap attachment means 107 with Velcro® mini hooks end portions 106 and Velcro® fiber mat end portion 113 from the platform 102 when the one footwear of the two footwear worn by the person is placed on the platform top so that the platform and the one footwear can move attached together during the navigation of the step change in the elevation and both hands of the person can be free for holding onto a safety hand railing,
wherein the platform bottom 105 is for contacting each step horizontal surface during the navigation of the step change in the elevation by the person,
wherein the platform 102 top is at a height 108 above the platform bottom 105,
wherein the height 108 of the platform 102 top above the platform bottom 105 is selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the platform 102 attached to the one footwear of the two footwear worn on the person is for standing on by the person during navigation of each horizontal surface of the step change in elevation,
wherein the platform 102 is for keeping the one footwear of the two footwear worn on the person at the height 108 above the platform bottom 105 during the navigation of the step change in elevation so as to reduce the amount of knee bending and the amount of fatigue of the person during the navigation of the step change in elevation, and
wherein the attachment of the platform 102 to the one footwear of the two footwear on the person is detachable by the person. The person using the present invention can disconnect the attachment means 107 end portions 106 and 113 from around the footwear that they are wearing after the person has accomplished navigation of the step change in elevation whether a single step or a flight of stairs.

One embodiment of the present invention is a step navigation assisting apparatus for attaching to just one of the two footwear worn on a person during a navigation of a step change in elevation to reduce amount of knee bending and amount of fatigue of the person during the navigation of the step change in elevation, the step navigation assisting apparatus comprising:
a platform 102 with a platform bottom 105; an attachment means 107 with end portions 106 and 113; and a platform top 102 with a top surface for placing the one footwear of the two footwear worn by the person,
wherein the platform 102 is for attaching to the one footwear of the two footwear worn by the person by the attachment means 107 with end portions 106 and 113 from the platform 102 when the one footwear of the two footwear worn by the person is placed on the top surface of the platform 102 top so that the platform 102 and the one footwear can move attached together during the navigation of the step change in the elevation and both hands of the person can be free for holding onto a safety hand railing,
wherein the bottom surface on the platform bottom 105 is for contacting each step horizontal surface during the navigation of the step change in the elevation by the person,
wherein the top surface of the platform 102 top is at a height above the bottom surface of the platform bottom 105 which is about one half of the distance of the step change in the elevation to be navigated by the person, the height 108 of the top surface of the platform 102 top above the bottom surface of the platform bottom 105 selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the platform 102 attached to the one footwear of the two footwear worn on the person is for standing on by the person during navigation of each horizontal surface of the step change in elevation,
wherein the platform 102 top is for keeping the one footwear of the two footwear worn on the person at the height 108 of the top surface of the platform 102 top above the bottom surface of the platform bottom 105 during the navigation of the step change in elevation so as to reduce the amount of knee bending and the amount of fatigue of the person during the navigation of the step change in elevation, and
wherein the attachment of the platform 102 to the one footwear of the two footwear on the person is detachable by the person. The one foot wear can be detached by disconnecting the attachment means 107 end portions 106 and 113 from around the footwear. Note that FIG. 6 schematically depicts use of an invention embodiment related to the embodiment schematic in FIG. 1. Also, note that left side of FIG. 6 in a highly schematic form, depicts an example step horizontal surface 608 during a navigation of the step change in the elevation 607 by a person 601 with an invention embodiment of the invention 604 which is similar to the embodiment depicted in FIG. 1. The Specification also points out the manner by which the present invention allows a person such as a disabled person to reduce the amount that their knees must bend during a navigation of a step change in elevation when the top surface of the platform 102 top is at a height above the bottom surface of the platform bottom 105 which is about one half of the distance of the step change in the elevation to be navigated by the person.

In some embodiments, the apparatus of the invention comprises a platform with an attachment means which is attached to just one of the two footwear worn by the person, wherein the footwear might be for example, a men's shoe, a women's shoe, a boot, a bedroom slipper, a sneaker, and the like footwear. For the present invention the term footwear is limited in scope and defined to mean an article of manufacture which is typically used as outer covering for the feet, and excludes a covering of the foot that is worn inside a footwear, and thus a woman's stocking, a sock, or a bare foot are not a footwear for the present invention.

One embodiment of the present invention is a step navigation assisting apparatus for attaching to just one of the two footwear worn on a person during a navigation of a step change in elevation to reduce amount of knee bending and amount of fatigue of the person during the navigation of the step change in elevation, the step navigation assisting apparatus comprising:
a platform 102 with a rectangular platform bottom 105; an elastic Velcro® mini-hooks and fiber mat strap attachment means 107 with Velcro® mini-hooks end portion 106 and a fiber mat end portion 113; and a rectangular platform 102 top with a top surface for placing the one footwear of the two footwear worn by the person,
wherein the platform 102 is for attaching to the one footwear of the two footwear worn by the person by the attachment means 107 with end portions 106 and 113 from the platform 102 when the one footwear of the two footwear worn by the person is placed on the top surface of the platform 102 top so that the platform 102 and the one footwear can move attached together during the navigation of the step change in the elevation and both hands of the person can be free for holding onto a safety hand railing,
wherein the bottom surface on the platform bottom 105 is for contacting each step horizontal surface during the navigation of the step change in the elevation by the person,
wherein the top surface of the platform 102 top is at a height above the bottom surface of the platform bottom 105 which is about one half of the distance of the step change in the elevation to be navigated by the person, the height 108 of the top surface of the platform 102 top above the bottom surface of the platform bottom 105 selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the platform 102 attached to the one footwear of the two footwear worn on the person is for standing on by the person during navigation of each horizontal surface of the step change in elevation,
wherein the platform 102 is for keeping the one footwear of the two footwear worn on the person at the height 108 of the top surface of the platform 102 top above the bottom surface of the platform bottom 105 during the navigation of the step change in elevation so as to reduce the amount of knee bending and the amount of fatigue of the person during the navigation of the step change in elevation, and
wherein the attachment of the platform 102 to the one footwear of the two footwear on the person is detachable by the person. The one footwear of the two footwear on the person is detachable by disconnecting the attachment means 107 end portions 106 and 113 from around the footwear. Note that FIG. 6 schematically depicts use of an invention embodiment related to the embodiment schematic in FIG. 1. Also, note that left side of FIG. 6 in a highly schematic form, depicts an example step horizontal surface 608 during a navigation of the step change in the elevation 607 by a person 601 with an invention embodiment of the invention 604 which is similar to the embodiment depicted in FIG. 1. The Specification also points out the manner by which the present invention allows a person such as a disabled person to reduce the amount that their knees must bend during a navigation of a step change in elevation when the top surface of the platform 102 top is at a height above the bottom surface of the platform bottom 105 which is about one half of the distance of the step change in the elevation to be navigated by the person.

Another embodiment of the present invention is a step navigation assisting apparatus for attaching to just one of the two footwear worn on a person during a navigation of a step change in elevation to reduce amount of knee bending and amount of fatigue of the person during the navigation of the step change in elevation, the step navigation assisting apparatus comprising:
a platform 102 with a platform bottom 105; an attachment means 107 with attachment means end portions 106 and 113; and a platform 102 top with a top surface for placing the one footwear of the two footwear worn by the person,
wherein the platform 102 top is for attaching to the one footwear of the two footwear worn by the person by the attachment means 107 with attachment means end portions 106 and 113 from the platform 102 when the one footwear of the two footwear worn by the person is situated on the top surface of the platform 102 top so that the platform 102 and the one footwear can move attached together during the navigation of the step change in the elevation and both hands of the person can be free for holding onto a safety hand railing,
wherein the bottom surface on the platform bottom 105 is for contacting each step horizontal surface during the navigation of the step change in the elevation by the person,
wherein the top surface of the platform 102 top is at a height 108 above the bottom surface of the platform bottom, the height 108 selected to be about one half of the distance of the step change in the elevation to be navigated by the person,
wherein the platform 102 attached to the one footwear of the two footwear worn on the person is for standing on by the person during navigation of each horizontal surface of the step change in elevation;
wherein the platform 102 is for keeping the one footwear of the two footwear worn on the person at the height 108 of the top surface of the platform 102 top above the bottom surface of the platform bottom 105 during the navigation of the step change in elevation so as to reduce the amount of knee bending and the amount of fatigue of the person during the navigation of the step change in elevation, and
wherein the attachment of the platform 102 to the one footwear of the two footwear on the person is detachable by the person. The one footwear of the two footwear on the person is detachable by disconnecting the attachment means 107 end portions 106 and 113 from around the footwear. Note that FIG. 6 schematically depicts use of an invention embodiment related to the embodiment schematic in FIG. 1. Also, note that left side of FIG. 6 in a highly schematic form, depicts an example step horizontal surface 608 during a navigation of the step change in the elevation 607 by a person 601 with an invention embodiment of the invention 604 which is similar to the embodiment depicted in FIG. 1. The Specification also points out the manner by which the present invention allows a person such as a disabled person to reduce the amount that their knees must bend during a navigation of a step change in elevation when the top surface of the platform 102 top is at a height above the bottom surface of the platform bottom 105 which is about one half of the distance of the step change in the elevation to be navigated by the person.

Note that in regard to the above description and limitations disclosed for embodiments of the present invention, that FIG. 6 depicts an invention embodiment 604 in use by a person 601 wherein the height of the platform is about one half of the step 607 change in elevation which is being navigated by the person 601 to accomplish the step change in the elevation depicted in the FIG. 6.

A preferred embodiment of the present invention is a step navigation assisting apparatus for attaching to just one of the two footwear worn on a person during a navigation of a step change in elevation to reduce knee bending and fatigue of the person during the navigation of the step change in elevation, the step navigation assisting apparatus comprising:
a rectangular platform 102 with a platform bottom 105; an elastic Velcro® mini-hooks and fiber mat strap attachment means 107 with end portions 106 and 113; and a platform 102 top with a top surface for placing the one footwear of the two footwear worn by the person,
wherein the platform 102 is for attaching to the one footwear of the two footwear worn by the person by the attachment means 107 (with end portions 106 and 113) from the platform 102 when the one footwear of the two footwear worn by the person is placed on the top surface of the platform top so that the platform and the one footwear can move attached together during the navigation of the step change in the elevation and both hands of the person can be free for holding onto a safety hand railing,
wherein the bottom surface on the platform bottom 105 is for contacting each step horizontal surface during the navigation of the step change in the elevation by the person,
wherein the top surface of the platform 102 top is at a height 108 above the bottom surface of the platform bottom 105,
wherein the height 108 of the top surface of the platform 102 top above the bottom surface of the platform bottom 105 is selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the platform 102 attached to the one footwear of the two footwear worn on the person is for standing on by the person during navigation of each horizontal surface of the step change in elevation,
wherein the platform 102 is for keeping the one footwear of the two footwear worn on the person at the height 108 of the top surface of the platform 102 top above the bottom surface of the platform bottom 105 during the navigation of the step change in elevation so as to reduce the amount of knee bending and the amount of fatigue of the person during the navigation of the step change in elevation, and
wherein the attachment of the platform 104 to the one footwear of the two footwear on the person is detachable by the person. The person using the present invention can disconnect the attachment means 107 end portions 106 and 113 from around the footwear that they are wearing after the person has accomplished navigation of the step change in elevation whether a single step or a flight of stairs.

For a number of embodiments of the present invention the attachment means preferably comprises a flexible elastic strap with a reversible fastener system at the end portions of the strap. The attachment means can be of any kind such as a strap, a string, a clamp, a groove in the platform in which the footwear can become reversibly wedged, a belt, but a preferred attachment means is an elastic Velcro® mini hooks and fiber mat strap system such as the one depicted in FIG. 1. A Velcro® mini hooks and fiber mat strap system is a preferred attachment means for the attaching of the platform to the one footwear on the person because the mini hooks and fiber mat end portions of the strap can be rapidly connected together and rapidly pulled apart in a matter of seconds and the Velcro® mini hooks and fiber mat strap system has a high lateral holding strength. A Velcro® mini hooks and fiber mat strap connector system is defined for the present invention to be a connector system comprising two materials: a mini-hooks material and a fiber mat material with the fiber mat material having loops of fibers into which the mini-hooks can become stuck when the two materials are put into contact and particularly when the two materials are pressed together. It is contemplated that there are many varieties of Velcro® mini hooks and fiber mat connector systems known in the art which can be used interchangeably in embodiments of the present invention.

When only one attachment means is used, then the attachment means is optimally used to hold down the footwear portion in front of the ankle of the person. In some embodiments of the invention, the platform can have more than one attachment means for the platform. Optionally, some of the embodiments of the present invention may use plural attachment means can allow one attachment means to wrap over the top of the footwear in front of the ankle while the second attachment means may wrap over the heel of the footwear behind the ankle of the person. Using just one attachment means for a platform of the invention is a preferred mode of attachment of the platform of many embodiments of the invention to the one footwear being worn on a person.

The attachment means of the platform of the invention may comprise any known material which can be reversibly and reliably attached from the platform to secure one footwear worn by the person to the platform. For example, the material comprising the attachment means may be a flexible strap or band selected of a material consisting of a nylon, a cotton, a polyester, a silk, a leather, a velour, a wool, a rubber, a hemp fiber, a plastic, another strong flexible material, and any combination thereof. Preferably, the material is elastic or has an elastic portion which is long lasting. The attachment means of the platform for some embodiments of the apparatus is conceived to be easily detached from the platform as wished, so as to replace or wash or to switch the attachment means when it has become worn, soiled, damaged or when the person using the invention wants to replace it for any reason. The person using the invention may wish to change the attachment means as a style switch in coloration to disguise the attachment means or just to make a fashion. It is conceived that a part of the attachment means in many of the embodiments of the present invention can be seen on top of the single piece of footwear worn by the person where the attachment means has to pass over a top section of the single piece of footwear worn by the person so as to hold the footwear securely on the top surface of the platform of the apparatus of the present invention. The reversibility of attaching the attachment means of the invention to a single piece of footwear worn by the person when they are using the invention is a preferred embodiment.

The location where the attachment means of the invention is attached to the footwear might be any location on the footwear however, typically the attachment means is anchored at a position within the front half of the platform length as depicted for example in FIG. 1. In FIG. 1, the front edge of the attachment means is a distance 109 from the front end of the platform 110. Using FIG. 1 merely as a schematic guide, the front edge of the attachment means is a distance 109. For a number of embodiments of the invention with a single attachment means, distance 109 is between about 15 percent to about 50 percent of the distance 103; preferably distance 109 is between about 20 percent to about 40 percent of the 103 distance; and even more preferably distance 109 is about 25 percent to about 35 percent of the distance 103.

In some embodiments the attachment means comprises a strap with a thickness can be between about one sixty-fourth of an inch to about one inch, the strap having a strap width of between about one-sixteenth of an inch to about four inches, more preferably between about one eighth of an inch to about three-eighths of an inch, and more preferably between about one-eighth of an inch to about one-quarter of an inch. In some embodiments the attachment means comprises a strap having a length of between about 10 inches to about 40 inches; preferably the strap has a length of between 15 inches to about 30 inches, and more preferably the strap has a length of between about 15 inches to about 25 inches. Examples of attachment means include: (1) a single continuous elastic synthetic material strap between about ½ to about 3 inches wide, preferably about 1 inch wide, and between about 1/16 to about ½ inch thick, preferably about ⅛ inch thick, with Velcro® hooks on an end portion of one side and a Velcro® fibrous mat on a portion of the other end with a total strap length of between about 12 inches and 24 inches, preferably 14 to 18 inches; (2) an elastic shoe lace which can be tied and easily untied; (3) an elastic synthetic foam rubber with Velcro® hook and fibrous mat connections or snap connectors; and (4) an elastic strap with holes and a buckle. Conceivably the strap can be selected to have a portion which is elastic and a portion which is not elastic, or the strap can be entirely not elastic, however preferably the strap has some elasticity. The connection between the ends of the attachment means is imagined to be accomplished by any kind of connector or connecting device provided that using the connector or connecting device is easy to connect and disconnect. Preferably, after the ends of the attachment means have been connected, then a later disconnecting of the ends of the attachment means can be done by a person using just one hand.

Snap fasteners also known as press studs are another fastener for reversibly and reliably connecting ends of some attachment means together. Snap fasteners can be metal or plastic. Buttons and holes are another fastener for reversibly and reliably connecting ends of attachment means together wherein the one end portion one or more holes material and one or more buttons at the other end of the material. Buttons often are of a metal or a plastic. Fasteners for holding together two ends of an attachment means for the present invention include metal connectors and plastic connectors selected from the group consisting of a Velcro® mini-hooks and fiber mat connector system, a button and hole connector, snap fasteners, press studs, hook buttons, collar hooks, hook connectors, buckles, clasp buckles, parachute buckles, zippers, magnets such as neodymium magnets and a combination thereof as well as any other known fasteners.

From extensive design testing to optimize performance of the invention for a person who experiences great pain when climbing stairs, and in accordance with the invention embodiment example depicted in FIG. 1, the Inventor finds that one particularly preferred embodiment of the present invention apparatus comprises: a rectangular platform 102 of a firm compressible plastic foam, weighing between about 6 ounces to about 16 ounces, having a width which is between about 5 to about 6 inches, wherein both the top platform and the bottom platform have a length 103 which is between about 7.5 to about 9.5 inches, and a platform height which is between about 2.8 to about 3.8 inches; and an attachment means 107. The attachment means 107 preferably comprises: an elastic plastic or nylon strap between about 16 to 20 inches long, between about 0.8 to about 2 inch wide, and between about 0.03 inches to about 0.2 inches thick. Preferably the attachment means 107 is quickly reversible and is a continuous strap passing through a horizontal slit hole running transverse between the side walls 104 and 112. Preferably the front edge of the continuous strap has a distance 109 from platform front end 110 which is between about 2 to about 3.5 inches, with the Velcro® mini hooks and fiber mat strap connector system on strap 107 having a Velcro® fiber mat end portion 113 and a Velcro® mini-hooks end portion 106 attached to other end of strap 107 as schematically depicted in FIG. 1.

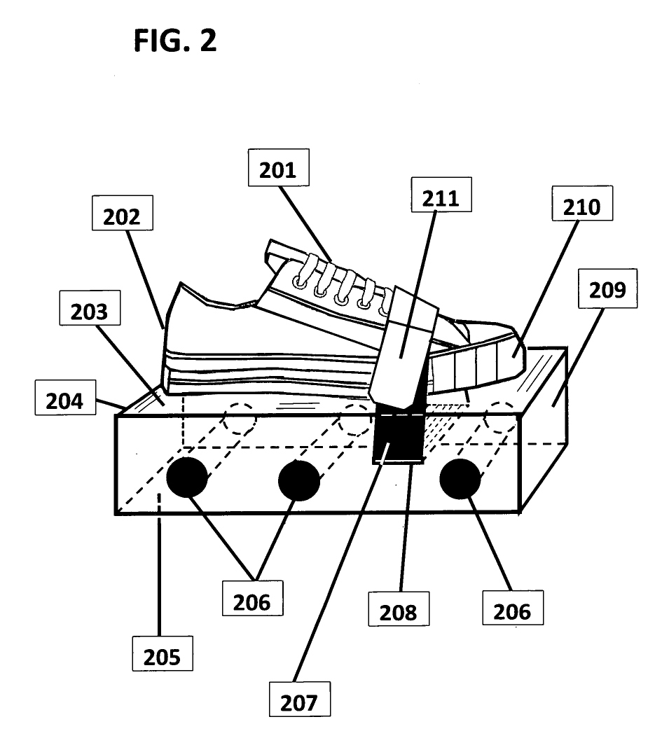

FIG. 2 schematically depicts a rectangular platform 204 embodiment of the invention having some similarities to the embodiment depicted in FIG. 1. FIG. 2 schematically depicts an example embodiment of the present invention with one footwear 201 attached to the apparatus comprising the platform 203; and an elastic Velcro® mini hooks and fiber mat strap attachment means 207 with end portion 211 visible. Footwear sneaker 201 with has a sneaker front 210 and a sneaker back side 202 is placed on platform top 203 so that the front of the footwear points to platform front end 209.

A preferred attachment means for the present invention is the elastic attachment means 207 with end portion 211 which together are a Velcro® mini hooks and fiber mat connector system attachment means which is schematically depicted in FIG. 2 invention embodiment. The footwear 201 is attached on platform top 203 of the platform 205 by the elastic strap Velcro® mini hooks and fiber mat connector system attachment means 207 with end portion 211. The attachment means comprises a 16 inch long by 1 inch wide by one-eighth inch thick elastic strap 207 which is a Velcro® fiber mat. At one end of the strap 207 is attached by glue or by sewing/stitches or other means, a three inch long plastic strip with a layer of Velcro® mini-hooks as the end portion 211 visible in FIG. 2. The Velcro® mini-hooks strip end portion 211 is three inches long by 1 inch wide and it makes an easy reversible resilient connection to the Velcro® fiber mat 207 so that the one footwear 201 worn by a person can lift the platform when the invention platform 205 is attached by this Velcro® mini hooks and fiber mat connector system attachment means to the footwear 201 during navigation of a step change in elevation by the person using the present invention. The Velcro® fiber mat attachment means 207 is attached to the platform by passing through a transverse slit hole 208 in the mid-section of the platform. Footwear 201 is attached to the platform by having Velcro® fiber mat connector system attachment means 207 stretched tightly over top of the lower laces section of the footwear 201 and then the Velcro® mini hook end strap portion 211, is pressed down on a portion of attachment means 207 fiber mat as depicted in FIG. 2 to connect the Velcro® mini hook and fiber mat connector system attachment means.

Also depicted in FIG. 2 is an option where side walls of platform 204 having a one or more plurality holes to lighten the weight of the platform. The platform can have holes for various benefits. In depicted FIG. 2 example invention embodiment, the platform 204 has three horizontal holes 206 going transversely across platform 204 from one side wall to the other side wall. Example uses for the holes in the platform 204 can include a location for inserting lighting for illumination or fun that might flash, and even conceivably could contain wireless directional signaling light or “brake light indications” to alert and avoid an accident with another step navigators when the person pauses in their navigation of a step change in elevation or decides to change direction during their navigation of the step. The holes might also contain a sound chip for an entertainment purpose. In some embodiments of the invention, the platform portion of the invention can be made lighter by having holes oriented in various directions in the platform and the holes could be reinforced with a second material. Any known materials could be used alone or in a combination to create the invention platform or the attachment means for some embodiments of the invention. The platform may have horizontal holes in a transverse direction as depicted in FIG. 2, horizontal holes in the direction of from the back to the front of the platform, vertical holes in the platform, a random hole design, holes of a varying diameter, or bubble-like cavities. The compressibility of the platform can also be modified by the structure of the holes and the selection of the platform material. It is conceived that for some embodiments of the present invention, adding holes to the platform is a means for reducing the platform weight by about 5 percent to about 10 percent, by about 10 percent to about 30 percent, by about 30 percent to about 50 percent, by about 50 percent to about 70 percent, or by about 70 percent to about 90 percent of the weight of a solid platform. The porosity of the embodiment can also be increased as a means for lightening the apparatus. Each embodiment of the invention is tested to be sure that it is made of a durable material and if the invention embodiment has any holes, then the embodiment is tested to see that the apparatus platform and attachment means work together as required and can withstand the expected weight and other forces that a person using the invention shall impose upon the apparatus when the apparatus is attached to the one footwear worn on the person and the invention embodiment is being used to navigate a step change in elevation.

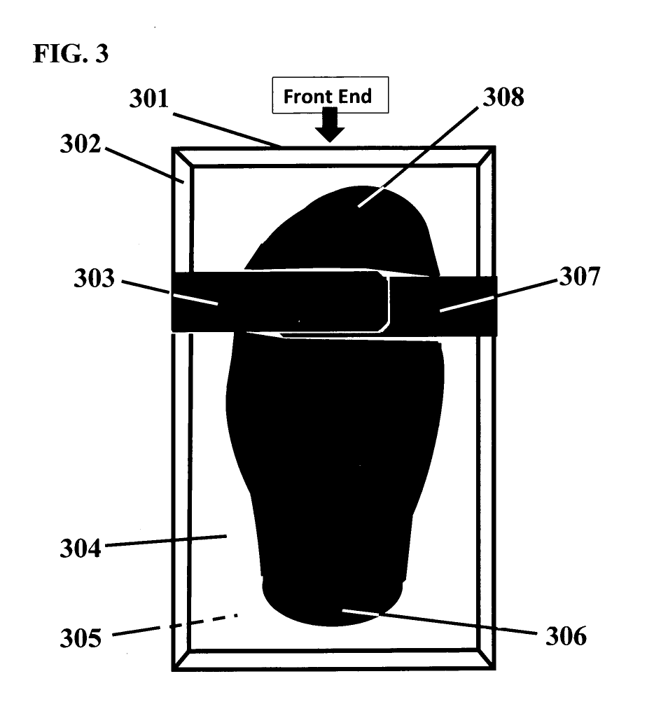

FIG. 3 depicts in a top view, another embodiment of the present comprising a platform with an attachable means with a footwear pattern front end 308 pointing to front end 301 of platform 304 to suggest the position for the footwear to be set down upon the platform. Attachable means is a Velcro® mini hook and fiber mat connector system as a strap connector system depicted in FIG. 3. A Velcro® mini hook end portion 303 and a Velcro® fiber mat end portion 307 are depicted as pressed down and connected together. The footwear pattern may be artfully decorated or reversibly held on with Velcro® mini hook and fiber mat connectors so as to be changeable by invention user to any artistic footwear pattern or art decoration. Also note the decorative chiseled margin 302 on the rectangular platform 304 which has a bottom surface 305 and footwear pattern back end 306. Many of the embodiments of the invention may have a footwear area which fits within the area of the platform 304. In FIG. 6, depicted invention apparatus 604 has a platform length similar to apparatus-attached footwear 603, with chiseled edge 402, platform bottom 405, side walls 408, and both apparatus 604 and footwear 603 are similar to length of step tread 608. A step tread can also be called a step horizontal surface.

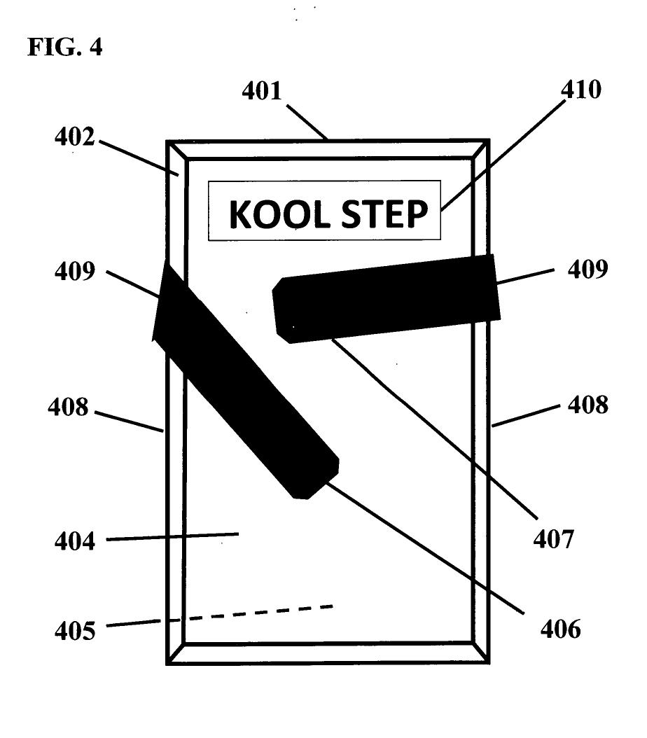

FIG. 4 depicts in a top view, an embodiment of the invention with “KOOL STEP” label 410 at front end 401 of platform 404 top. Footwear can be positioned pointing to label 410 and the depicted attachable means of the platform is a strap 409 using a Velcro® mini hook and fiber mat connection system for end portions 406 and 407 for quickly and reversibly attaching just one of the two footwear of disabled person to the platform top. The label “KOOL STEP” 410 is one way to play up the fun of being able to be “Kool” to independently tackle navigating a step with confidence.

Another possible label is “Cool-Step” or “Step-Up” for another embodiment of the present invention. A choice of iridescent colors with a “COOL-STEP” label on the top of the step. The iridescent colors would be an added safety feature which would help highlight the step for easier and safer use and seniors do still like to be “cool”. It is contemplated that the Step-Up invention can be made available in cool bright colors for seniors who think young.

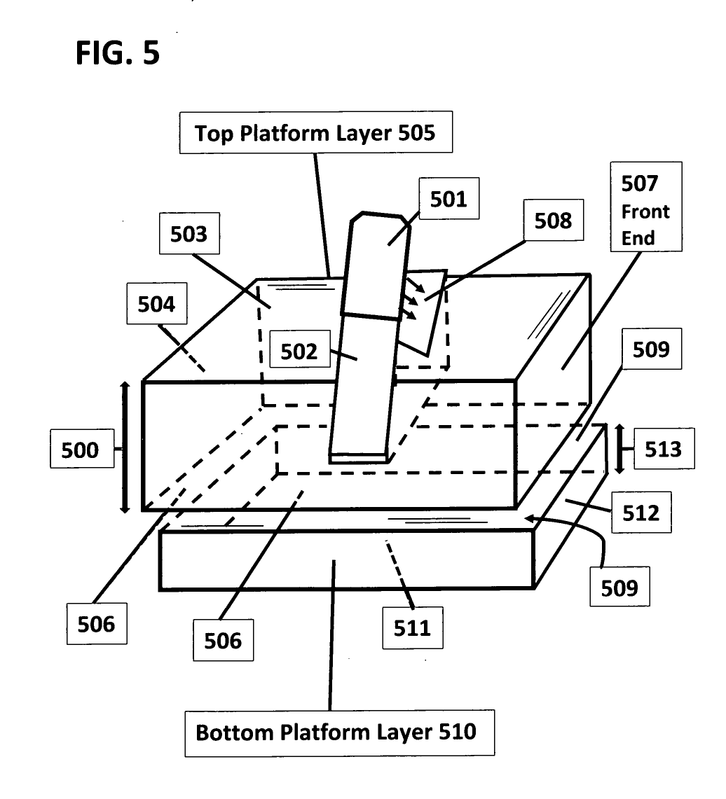

FIG. 5 depicts schematically an embodiment of the present invention which comprises a two-piece adjustable height platform system with front end 507 and back end 504. The two-piece adjustable height platform system comprises: one piece which is a platform top layer 505; an attachable means 502 with end portions 501 and 508; and a second piece which is a platform bottom layer 510 with front end 512 and bottom 511. In FIG. 5 the two-piece platform parts are separately depicted but closely juxtaposed. When the two-piece platform is in use by a person, then the two pieces of the platform are connected together using a connection means which can be for example, a Velcro® mini-hooks and fiber mat connector system or any fastener system or connector known in the art. The connection means can be situated between platform top layer 505 and platform bottom layer 510, or along sides of platform top layer 505 and platform bottom layer 510. It is contemplated that the connection means can be situated or anchored anywhere on a platform embodiment of the invention. Platform top layer 505 has a bottom area 506 which may have a fiber mat surface (felt-like) as the “loops material” for one side of the Velcro connector system. Platform bottom layer 510 has a top area 509 with some portion of area 509 having a surface of Velcro® mini-hooks as the “hooks material” for a Velcro® connector system as a connection means for reversibly connecting the platform top layer and platform bottom layers. For some embodiments of the invention, it is contemplated that any fastener or connector might be considered useful as a connection means for reversibly connecting the one or more platform top layer(s) and the one or more platform bottom layer(s) together.

In FIG. 5, the height 500, which when measured is also the thickness 500 of the platform top layer 505, measured out at far left of FIG. 5 by vertical dimension marker 500. Height 513, which when measured is also the thickness 513 of the platform bottom layer 510, is measured out at far right by vertical dimension marker 513. Platform top layer 505 has a platform top 503, front end 507, back end 504, platform bottom area 506, and attachment means 502 with end portions 508 and 501. Both platform top layer 505 and platform bottom layer 510 are in close proximity juxtaposed in FIG. 5. As mentioned, a Velcro® mini-hooks and fiber mat connector system is one of the preferred methods of attachment between these two platform layers 505 and 510. A plurality of snap connectors system could be used. A surface of Lego panel dimples and a surface of Lego panel backside depressions could for making and breaking apart different sized thickness platform top layers and platform bottom layers.

Preferably the adjustable height platform system-comprises an adjustable height platform with an attachment means, wherein the adjustable height platform comprises a top platform layer with the attachment means, the top platform layer connected reversibly to one or more bottom platform layers by a connecting means between each of the platform layers. Preferably the adjustable height platform system comprises at least two platforms with an attachment means attached from the top platform layer, wherein the total height of the platforms is selected to be about one-half of a step change in elevation chosen to be navigated by the person using the adjustable height platform system.

In accordance with the schematic depiction in FIG. 5, to create the adjustable height platform system as needed for a wide range of step changes in elevation, a person could use a “Step-Up” adjustable height platform kit. For example, the “Step-Up” adjustable height platform kit in some embodiments comprises: (a) a top platform layer 505 of 2.5 or 3 inches height 500 with a Velcro® mini-hooks and fiber mat attachment means 502 with mini-hooks end portions 501 and fiber mat end portions 508 for attaching the one footwear of the person to top platform layer 505 as depicted as for example depicted in FIG. 5; and (b) one to three bottom platform layers 510 of for example, −0.5, 1, 1.5, and 2 inches height 513. Some of the bottom platform bottom layers have a fiber mat on both top and bottom surfaces. Some of the top platform layers have a bottom area with a Velcro® mini-hooks material. Thus the “Step-Up” adjustable height platform kit provides a means for making a large number of different Velcro® mini-hooks and fiber mat connector system connections between the top platform layer(s) 505 and the bottom platform layer(s) 510 as may be needed for assembly by a person wishing to design an invention embodiment for their specific needs. The invention embodiment when connected all together can have a top platform height 500 plus a bottom platform height 513 as an adjusted new height platform with an attachable means ready for use connector system.

In some embodiments of the invention, the method of using an adjustable height platform kit to make a custom “new height” platform with an attachable means so that a person is a method comprising:
choosing a total height in inches for the custom new height platform with an attachable mean based on expected step change in elevation to be navigated by the person;
selecting a bottom platform layer 510 to be combined with a top platform layer 505 having an attachable means using an adjustable height platform kit to make the total height of the custom height platform; and
attaching a Velcro® mini-hooks and fiber mat connector system between the platform layer 505 and the bottom platform 510 layer for connecting the top platform layer 505 and the bottom platform layer 510 to make the custom new height platform with the attachable means. Additional bottom layers might be added below platform bottom layer 510 if needed

In some embodiments of the invention, the method of using an adjustable height platform kit to make a custom “new height” platform with an attachable means so that a person can navigate a step change in elevation, is a method comprising:
choosing a total height in inches for the custom new height platform with an attachable means based on expected step change in elevation to be navigated by the person;
selecting a platform bottom layer 510 to be combined with a platform top layer 503 having an attachable means using an adjustable height platform kit to make the total height of the custom height platform; and
attaching a Velcro connector system between the top platform layer 503 and the bottom platform 510 layer for connecting the top platform layer 503 and the bottom platform layer 510 to make the custom new height platform with the attachable means so that the person can navigate the step change in elevation. Additional bottom layers might be added below platform bottom layer 510 if needed.

FIG. 5 is a schematic example embodiment of a two piece adjustable height platform system of the present invention which can also be called an adjustable height step navigation assisting apparatus. The adjustable height step navigation assisting apparatus comprises: an adjustable height platform with a bottom platform layer 510; an attachment means 502 with end portions 501 and 508; and a top platform layer 505. Top surface of top platform layer 505 is for placing the one footwear of the two footwear worn by the person. The adjustable height platform is for attaching to the one footwear of the two footwear worn by the person by the attachment means 502 with end portions 501 and 508. The one footwear of the two footwear worn by the person is for standing on the top surface 503 of the top platform top layer 505. The adjustable height platform and the one footwear can move attached together during the navigation of the step change in the elevation and both hands of the person can be free for holding onto a safety hand railing. The adjustable height platform has a bottom surface 511 on the bottom platform layer 510, a front wall 512, which is for contacting each step horizontal surface during the navigation of -the step change in the elevation by the person.

In FIG. 5, the depicted invention embodiment has a height, which is the height of the top surface of the platform top layer above the bottom surface of the platform bottom layer, and this height is the result of connecting together the upper platform layer and the lower platform layer by a connecting means. For example, the platform top layer can have a bottom area connected using a Velcro® connection system to a top area of the platform bottom layer. In a preferred embodiment, the bottom area of the platform top layer has a surface area with a material of Velcro® mini-hooks that can connect with a surface area of a material of fiber mat “loops” located on the top area of the platform bottom layer as means for easily making a secure and reversible connection. It is also contemplated that in other embodiments of the invention, that the bottom area of the platform top layer can be the surface area with a material which is a fiber mat of “loops” that can connect with a surface area of a material of Velcro® mini-hooks located on the top area of the platform bottom layer, as another means for easily making a secure and reversible connection. In either of the orientations of the Velcro® connector system “loops” and “hooks” between the upper platform layer and the platform bottom layer, the Velcro® connections can be reversibly connected together. When connected together the combination of the connected platform layers can suitably function as an invention embodiment apparatus comprising an adjusted height platform which has a custom “new height” with an attachment means for attaching the one footwear worn on the person so that the person can use the customized apparatus to navigate a step change in the elevation which the person believes is more comfortably navigated with the platform height has been adjusted to the new height.

The Velcro® mini-hooks and fiber mat connection system is capable of being disconnected when the person decides the height of the top platform top layer 505 above the bottom surface of the and the bottom platform layer 510 needs to be changed (“adjusted”) to a new height. Preferably the bottom platform layer 510 in the adjustable height platform system depicted in FIG. 5 can be replaced with another height 513 bottom platform layer 510 when the height top platform layer 505 above the bottom surface of the bottom platform layer is to be changed to another height. Alternatively, the top platform layer of the adjustable height platform system might be replaced with another thickness height top platform top layer. The new height of the invention platform layer can be adjusted as has been described here in the Specification and as is suggested by FIG. 5. Note that FIG. 5 only depicts using two connectable platform layers to create the new height platform part of the invention embodiment and more than two platform layers might be used to create the new height of the platform of the adjustable height navigation assisting apparatus.

For some embodiments of the invention, the new height of the adjustable height navigation assisting apparatus maybe selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches. The adjustable height platform attached to the one footwear of the two footwear worn on the person can be stood on by the person on each sequential horizontal surface of the navigated step change in elevation. The adjustable height platform is for keeping the one footwear of the two footwear worn on the person elevated at the height of the top surface of the platform top layer above the bottom surface of the platform bottom layer during the navigation of the step change in elevation so as to reduce the amount of knee bending and fatigue of the person during the navigation of the step change in elevation. The attachment of the platform to the one footwear of the two footwear on the person is detachable so that the person can go back to just walking in their footwear on level surfaces.

Another embodiment of the present invention is an adjustable height step navigation assisting apparatus for attaching to just one of the two footwear worn on a person during a navigation of a step change in elevation to reduce amount of knee bending and amount of fatigue of the person during the navigation of the step change in elevation, the adjustable height step navigation assisting apparatus comprising:
an adjustable height platform with a bottom platform layer; an attachment means; and a top platform layer with a top surface for placing the one footwear of the two footwear worn by the person,
wherein the adjustable height platform is for attaching to the one footwear of the two footwear worn by the person by the attachment means from the adjustable height platform when the one footwear of the two footwear worn by the person is placed on the top surface of the top platform layer so that the adjustable height platform and the one footwear can move attached together during the navigation of the step change in the elevation and both hands of the person can be free for holding onto a safety hand railing,
wherein the adjustable height platform has a bottom surface on the bottom platform layer, the bottom surface for contacting each step horizontal surface during the navigation of the step change in the elevation by the person,
wherein the top surface of the top platform layer is at a height above the bottom surface of the bottom platform layer,
wherein the top platform layer has a bottom area for connecting by a Velcro® mini-hooks and fiber mat connection system to a top area of the bottom platform layer,
wherein the Velcro® mini-hooks and fiber mat connection system between the bottom area of the top platform layer and the top area of the bottom platform layer is for disconnecting when the person decides the height of the top surface of the top platform layer above the bottom surface of the bottom platform layer is to be changed to a new height,
wherein the bottom platform layer in the adjustable height platform can be replaced with a different height bottom platform layer when the height of the top surface of the top platform layer above the bottom surface of the bottom platform layer is to be changed to the new height, and optionally the top platform layer in the adjustable height platform can be replaced with another height top platform layer when the height of the top surface of the top platform layer above the bottom surface of the bottom platform layer is to be changed to the new height,
wherein the new height of the top surface of the top platform layer above the bottom surface of the bottom platform layer can be selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the adjustable height platform attached to the one footwear of the two footwear worn on the person is for standing on by the person during navigation of each horizontal surface of the step change in elevation;
wherein the adjustable height platform is for keeping the one footwear of the two footwear worn on the person at the height of the top surface of the adjustable height platform above the bottom surface of the bottom platform layer during the navigation of the step change in elevation so as to reduce the amount of knee bending and the amount of fatigue of the person during the navigation of the step change in elevation, and
wherein the attachment of the platform to the one footwear of the two footwear on the person is detachable by the person.

In U.S. houses built in the 1700s-1800s, stairs from the first floor to the second floor are steeper than today and have sometimes a step change in elevation of more than 8.5 inches in height. Current U.S. and International building “codes” generally state that a normal step has a vertical height, step riser or step change in elevation of between about 7 to about 8 inches, usually a step change in elevation of not more than 7.75 inches. Preferred embodiments of the present invention have a platform height that is about one-half of the step change in elevation to be typically navigated at home or in public. A preferred height for the platform of the present invention is between about 3.5 to about 4 inches. However, not all step changes in elevation are to “code”. Many places such as bus steps, one stair decks, and old stairs are problematic in having a high step and these high steps are often where a person needs to directly navigate the step change in elevation. To deal with such occurrences, some embodiments of the present invention are useful, particularly useful when height of the invention embodiment platform is higher than one-half of the normal “code” step height of between 7 to 8 inches. Accordingly there is a need for a wide range of platform heights given step changes in elevation can range up to 14 inches for a bus step from the street into the bus, especially if the bus cannot lower its entrance step height hydraulically. Thus for some invention embodiments, the height of the platform of the invention is selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches. The step change in the elevation can also be called the step height, the step rise, or the riser height.

The invention is a Step Navigation Assisting Apparatus but a name to remember for the apparatus embodiments of the present invention is “Step-Up”. A Step-Up embodiment of the present invention needs to be attached to just one footwear of the two footwear worn on a person before the person navigates a step change in elevation. At other times, the Step-Up may easily be carried by hand or in a bag due to its light weight and small size. The person can sit on a step, chair, bed, or bench for example, and then attach a Step-Up invention embodiment to just one of their two footwear. Alternatively, another person can help them get their one footwear attached to a Step-Up embodiment of the invention. A disabled person can then stand and then navigate each step change in elevation with less knee pain and fatigue. The Inventor has had tested many embodiments of the present invention on many kinds of step changes in elevation, including tour bus steps, indoor apartment stairs between floors, New York City apartment stairs, outdoor steps in Rome, Italy, and stair steps to a train station in La Spezia, Italy. The Inventor has surprisingly observed that a person using an embodiment of the Step-Up invention according to the below methods for ascending or descending a step change in elevation can reduce the amount of pain they suffer from the amount of knee bending and can reduce the amount of fatigue during the step change in elevation. This is extremely important and vital for the well-being of a person with the health disabilities described herein.

Method for Ascending a Step Change in Elevation Using the Step-Up Invention. Firstly, the height of the platform of the invention embodiment is selected by the person to be about one-half of the height of the step change in elevation the person intends to navigate. Secondly, the person picks which one of their footwear to attach to the platform of the invention embodiment and then uses the attachment means to attach the one footwear on top of the platform of the selected height invention embodiment. It is suggested that when using Step-Up for ascending a step change in elevation, it may be easier and less painful to choose to place and attach the one footwear which is worn on the leg with the weaker knee or the knee with a medical problem. Thirdly, the person stands in front of the step change in elevation with one footwear standing directly on the horizontal step surface below the step change in elevation and with their other footwear is standing attached onto the top of the platform embodiment of the invention which is also on the horizontal step surface below the step change in elevation. Fourthly, the person first lifts their footwear not attached to the invention platform, and sets their footwear attached to the invention platform on the next higher horizontal surface at the step. Note that this is schematically depicted in FIG. 6 for person 601 using an invention embodiment 604 to navigate a step 607 change in elevation. Fifthly, the person lifts their footwear attached to the invention platform and places their footwear attached to the invention platform on the horizontal surface at the top of the step where their footwear not attached to the invention platform is located. Sixthly, should the person have more steps to climb then Steps 3 to 5 are repeated until the person is at the top of their last step change in elevation. Lastly, the person detaches the invention platform from the one footwear that it had been attached to and puts away their Step-Up invention, in for example their day knapsack.

Methods for Descending a Step Change in Elevation Using the Step-Up Invention: Firstly, the height of the platform of the invention embodiment is selected by the person to be about one-half of the height of the step change in elevation the person intends to navigate. Secondly, the person picks which one of their footwear to attach to the platform of the invention embodiment and uses the attachment means to attach the one footwear to the top of the platform of the selected height invention embodiment. It is suggested that when using Step-Up for descending a step change in elevation, it may be easier and less painful to choose to place and attach the one footwear which is worn on the leg with the stronger knee or the knee without a medical problem. Thirdly, the person stands in front and on top of the step change in elevation with one footwear standing directly on the horizontal step surface on top of the step change in elevation and with their other footwear is standing attached onto the top of the platform embodiment of the invention which is also on top of the horizontal step surface below the step change in elevation. Fourthly, the person first lifts their footwear attached to the invention platform and sets their footwear attached to the invention platform on the next lower horizontal surface at the step. Fifthly, the person lifts their footwear (not attached to the invention platform) and places their footwear (not attached to the invention platform) on the horizontal surface at the lower horizontal step surface where their footwear attached to the invention platform is located. Sixthly, should the person has more steps to descend then Steps 3 to 5 are repeated until the person is at the bottom of their last step change in elevation. Lastly, the person detaches the invention platform from the one footwear that it had been attached to and puts away their Step-Up invention, in for example their day knapsack.

It is conceived that the person who uses the present invention may have a medical disability or be elderly and have a difficulty navigating what is a typical step change in elevation, whether going up or going down the step change in elevation. For example, the person may be a disabled person. The person may have a muscle injury, may have a joint injury, may have arthritis, may be recovering from a leg surgery, may have a muscle or joint disease, may have muscle weakness, may lack stamina and easily fatigue, may have asthma or a lung dysfunction, may be an elderly person who is weak and fragile, may have a difficulty because the step is too high, and/or another or the like difficulties navigating a step. The invention can help to lessen knee bending, pain and fatigue of the person going up or going down the step. The step may be a single step change in elevation or may be a plurality of steps such as for example in a flight of stairs. Well known examples of step changes in elevation that a person may need to go up or to go down include the step changes which can be selected from the group consisting of a street curb, stairs between floors in a house, stairs between floors in an apartment, stairs between floors in a building, a step up to a bus from a road surface, a step down from the bus to a road surface, cellar stairs, stairs going down from a sidewalk elevation to a subway platform, stairs from a subway platform to the street elevation, the step up from a ground surface to a train entryway, the step down from the train to the ground surface, fire escape stairs in a building going down to the street, stairs on a ship, ascending or descending steps in a park or patio, step stool step, step ladder steps, stairs in a sports stadium to seats, and the like situations in which a person may encounter a step.

Many disabled persons have a difficulty navigating a step or stairs because they have damage to one of their knee joints or to muscles in the leg or back. The person may feel sharp pain and have stiffness from the damage to their body which becomes more painful when they bend their knee or put too much weight upon their knee by over-extending their leg to navigate a step change in elevation. The disabled person may not exercise and may fatigue when navigating stairs or a high step. The pain or fatigue can interfere with their attention, their coordination, and balance. To be safe, a disabled person needs to have both of their hands free so as to be able to grab or hold onto a hand railing when they have pain, when they feel weak or when they are fatigued or light-headed or need to rest for a time. An elderly person who falls on stairs may easily break a bone or suffer a serious head trauma.

FIG. 6 depicts a schematic of a person 601 using an embodiment of the present invention on one footwear of their two footwear to navigate a step change in elevation 607 on stairs 605. Person 601 has a back leg 602 in a footwear 603 which is attached to an embodiment of the present invention which is platform 604 with an attachable means 606. The height of the invention embodiment platform 604 is about one-half of step height 607. Even though the other footwear 609 of the person 601 is on an upper step surface 608, the person 601 has an only slightly-bent knee 610 because of the elevation of back leg 602 in a footwear 603 which is attached to an embodiment of the present invention which is platform 604 with an attachable means 606. Note that the set of stairs 605 are identical in all dimensions to the set of stairs 614. FIG. 6 although schematic in its depictions is useful to clear and particularly point out one of the ways that the present invention advantageously and surprisingly reduces the amount of knee bending by knee 610 compared to knee 618. It is only after conceiving of the invention and optimizing various parameters of the Step-Up invention that the Inventor can provide FIG. 6 to illustrate one use of the present invention during one stage of its use by a person during a navigation of a step change in elevation by the person.

Also depicted in FIG. 6 is a schematic of a second person 611 who is same in body height and leg dimensions as person 601. However, person 611 is navigating the step change in elevation 615 without using an embodiment of the present invention on footwear 613 of back leg 612. Note that the Step 607 change in elevation and step 615 change in elevation are the same step change in elevation. The front leg of person 611 is positioned with front leg footwear 617 to make a full step height lift to get their footwear 617 on upper step surface 616. For person 611, this requires that the front knee 618 of person 611 become significantly bent and this is depicted in FIG. 6. To navigate the same step change in elevation, the front thigh of person 611 has to be lifted much higher from hip of person 611 than does the front thigh of person 601 because person 601 is using invention embodiment platform 604 which elevates their footwear 603 by half of the step change in elevation. A person who is disabled may experience pain when have to bend their knee significantly and they can become fatigued if they have to significantly lift their thigh from their hip. Accordingly, FIG. 6 clearly illustrates the manner in which an embodiment of the present invention can reduce the amount of knee bending and the amount of fatigue suffered by a person navigating a step change in elevation.

The significantly bent knee 618 and high leg lift problems depicted in FIG. 6 for the person 611 are a well-known problem suffered especially by disabled people having a disabled leg or knee medical condition. However, there has been no convenient invention disclosed in the prior art or advertised for sale which is safe and effective and which is not a cumbersome electric stair lift, electric elevator, or wheel chair. A disabled person would rather sit and do nothing rather than suffer increased knee pain in attempting such a step climb during which they may become stressed. This depressing problem had not been solved by any prior art apparatus. Now the problem has been specifically solved by the Inventor of the present invention whose invention comprises many invention embodiment designs as a customized efficient thoughtful solution to the step navigation problem commonly upsetting many disabled persons and elderly persons (the “Seniors”). The present invention in many ways and designs is surprisingly successful in insuring the safety of a senior given their increased susceptibility to serious injury. The present invention is easy to use, convenient carry and store, lightweight and instills great and renewed confidence in a person with step navigation difficulties who needs to independently navigate a step change in elevation in their home and in public places.

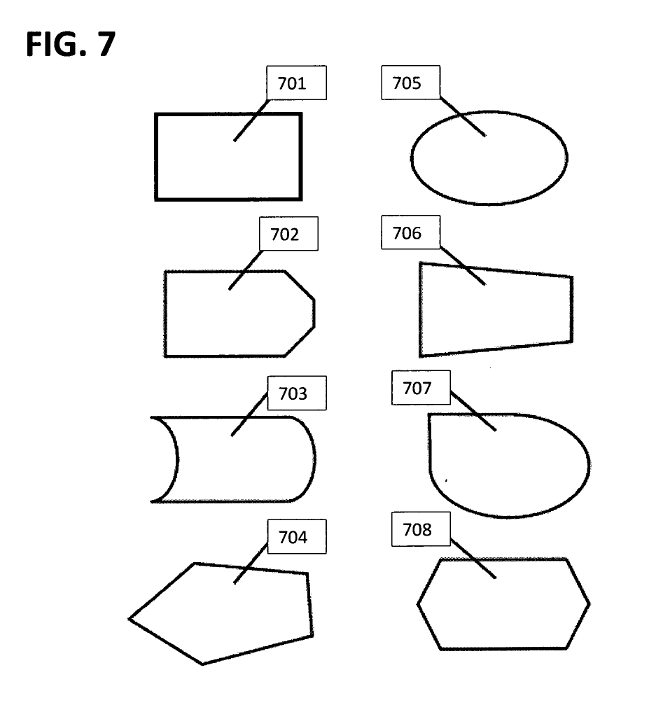

Diagrammed in FIG. 7 are as seen from a top view are eight examples of contemplated invention embodiment design. Diagram shows a top view appearance of platform top shapes and should be viewed applicable for platform bottom shape designs for some embodiments of the present invention. For reference also that FIG. 3 and FIG. 4 are top view depictions of a rectangular shape platform embodiment of the invention and in such depictions the platform top and bottom are same top view shape. The front end of the eight platform designs in the diagram below is on the right side of each design shape depicted. Stated in other words, the front end of each design shape points to the right. Attachment means is/are not depicted in the diagram of these designs but the attachment means would be attached to a platform with such shape designs in accordance with what is taught in the Drawings (FIGS. 1-6) and by the Detailed Description of the Invention of the specification. Shape embodiments are depicted in FIGS. 1, 2, 3, 4, and 5 that are a preferred embodiment. The length of the rectangular embodiment is preferably not longer than the length of the footwear worn by the person. Rounded platform shapes 2, 5, and 6 are an optional embodiment for a person who may need to rotate their platform position on a step surface while navigating a step change in elevation and does not want a pointed platform side wall edge to jut the platform further out from the back of the step and risk the platform sticking off the step too much and causing a stability problem for the person navigating the step. Polygonal platform shapes 3, 4, 7 and, 8 are an optional embodiment for a person who may want their apparatus platform flush but need the platform on the step surface at a non-90 degree angle against a vertical face of a step. FIG. 7 provides top view generic depictions of eight example platform shapes for the invention: a rectangular platform shape 701; a chiseled front, six-sided platform shape 702; a convex front with concave back platform shape 703; a flat front with pointed back five sided platform shape 704; an oval platform shape 705; a truncated front cone platform shape 706; a 90 degree back corner oval platform shape 707; and pointed front and bad end hexagonal platform shape 708. Note that for some embodiments of the invention, the platform top and platform bottom can have the same shape. Also note that the front end each platform shape points to right side of FIG. 7 and that the attachment means of the invention is not depicted.

In some embodiments, the present invention is an apparatus which comprises a reversibly-attachable single platform for attaching to only one of the two footwear on the person. They may attach the invention to a footwear just prior to the time when the person needs to climb or descend a step or stairs. The platform comprises: a platform top connected to a platform base; and there is a means for attaching the platform to a footwear worn on the person. The platform is preferably attached to the footwear of the person when the footwear is being worn on a foot of the person. The other foot of the person simply wears their footwear during use of the invention. The person can attach the present invention beneath a piece of their footwear when for example the person is sitting in a chair, seat, bench, a step, or on the ground. The person may need assistance in attaching the platform if bending over is difficult or painful for them. The person might be standing provided that someone is helping to attach the platform to the bottom of their footwear. The present invention is an apparatus comprising a platform with an attachable means for attaching temporarily to just one of the footwear worn on a person needing to navigate a step or stairs either up or down the step or steps in a safe manner with hands free and so as to reduce the amount of: bending of their knees; lifting of their legs; and fatigue they will experience during a navigation of one or more step changes in elevation such as on a flight of stairs.

In some embodiments of the present invention, the ratio of the width of the platform to the width of the footwear attached to the platform is a percentage selected from the group consisting of between about 25 percent to about 250 percent, between about 50 percent to about 200 percent, between about 75 percent to about 200 percent, between about 100 percent to about 160 percent, and between about 110 percent to about 150 percent; and between about 90 percent to about 150 percent. For example in some embodiments of the present invention, the ratio of the length of the platform to the length of the footwear attached to the platform is a percentage selected from the group consisting of between about 25 percent to about 250 percent, between about 50 percent to about 200 percent, between about 75 percent to about 200 percent, between about 100 percent to about 160 percent, and between about 110 percent to about 150 percent; and between about 90 percent to about 150 percent.

For some embodiments of the present invention, the apparatus comprises a platform which may be made of a light weight, waterproof, water-resistant and/or chemical and oil resistant material. The material should be resistant to the oils often found on the ground in parking lots. The platform of the apparatus which is the invention can be made of a variety of materials, provided that the material is stable to sunlight, moisture, freezing temperatures and household chemicals. For some of the embodiments of the invention, a platform material for making a platform can be a material selected from the group consisting of a lightweight foam rubber, a plastic, a dense foamed plastic, an elastic porous material, a foam core with a rubber or plastic coating as a shell on one or more sides, a polymeric foam, a urethane foam, a closed cell foam, Aqua Cell® polyvinyl chloride foam, a polyurethane foam, a polystyrene, a sculpture foam, a balsa wood, a woven fabric around a block of a stiff material, and a combination thereof. It is also contemplated that the platform might comprise a lightweight wood or a woven fibrous material such as a wicker, hemp, or straw or any other material which can be used to make a platform which can support the weight of a person who would need to the use the present invention, such as a person weighing between 100 to 350 pounds. The platform top and platform bottom may have a non-slip surface. The present invention is also suitably designed for use by a child. A material can also be selected for the platform which is not compressible or is only partially compressible. For some embodiments the platform, when stood upon by an adult or child, then the thickness of the platform is compressed by between about 50 percent to about 100 percent, by between about 70 percent to about 100 percent, by between about 75 percent to about 90 percent, by between about 90 percent to about 100 percent, and by between about 90 percent to about 95 percent of its unloaded platform thickness.

Certain terminology may be used in the following description for convenience only and is not limiting. The words “lower” and “upper” and “top” and “bottom” designate directions in the drawings to which reference is made. The terminology includes the words above specifically mentioned, derivatives thereof and words of similar import. The use of the word “or” when stating for example the expression “A or B” is also intended to signify stating the expression “A and B”. However, the use of the word “and” when stating for example the expression “C and D” is not intended to signify stating the expression “C or D”. Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “a tip” includes a plurality of tips. Thus, for example, a reference to “a method” includes one or more methods, and/or steps of the type described herein and/or which will become apparent to those persons skilled in the art upon reading this disclosure. Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

It will be appreciated by those skilled in the art that changes could be made to the embodiments described above in writing, in a diagram, in a drawing, and in a figure without departing from the broad inventive concept thereof. It is understood, therefore, that this invention is not limited to the particular embodiments disclosed, but it is intended to cover modifications within the spirit and scope of the present invention as defined by the appended claims.

1. A step navigation assisting apparatus for attaching to just one footwear of two footwear worn on a person during a navigation of a step change in elevation to reduce an amount of knee bending and fatigue of the person during the navigation of the step change in the elevation, the step navigation assisting apparatus comprising:
a platform with a platform bottom surface, a platform top surface, one platform front end, and at least two platform side walls; and
one attachment means,
wherein the platform top surface is for placing the one footwear of the two footwear worn by the person,
wherein the platform has a single horizontal transverse slit hole between the two platform side walls in front half of the platform,
wherein the one attachment means is one continuous strap,
wherein the one continuous strap passes through the single horizontal transverse slit hole between the two platform side walls in the front half of the platform as means to anchor the one continuous strap to the platform,
wherein the one continuous strap has two end portions with a connector system for connecting the two end portions of the one continuous strap together on top of the one footwear in front of the ankle when the one footwear is placed on the platform top surface so as to attach the one footwear to the platform so the platform and the one footwear can move attached together during the navigation of the step change in the elevation so as to allow both hands of the person to be free for holding onto a safety hand railing if needed by the person during the navigation of the step change in the elevation,
so
wherein the platform bottom surface is for contacting each step horizontal surface during the navigation of the step change in the elevation by the person,
wherein height of the top surface of the platform top above the bottom surface of the platform bottom is selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the platform attached to the one footwear of the two footwear worn on the person is for keeping the one footwear of the two footwear worn on the person at the height of the platform top surface above the platform bottom surface during the navigation of the step change in the elevation so as to reduce the amount of the knee bending and the fatigue of the person during the navigation of the step change in the elevation by the person, and
wherein the attachment of the platform to the one footwear of the two footwear on the person is detachable.

2. The step navigation assisting apparatus according to claim 1,
wherein the one continuous strap is a continuous elastic strap.

3. The step navigation assisting apparatus according to claim 1,
wherein the connector system at the two end portions of the one continuous strap has a fiber mat end portion and a mini-hooks portion.

4. The step navigation assisting apparatus according to claim 1,
wherein the platform top surface has a platform top perimeter selected from the group consisting of a rectangular platform top perimeter, a rounded platform top perimeter, a polygonal platform top perimeter, and any combination thereof, and
wherein the one continuous strap is glued in the single horizontal transverse slit hole so the one continuous strap does not slide in the single horizontal transverse slit hole when the one continuous strap is pulled by the person.

5. The step navigation assisting apparatus according to claim 1,
wherein the platform is made with a material selected from the group consisting of a lightweight foam rubber, a plastic, a dense foamed plastic, an elastic porous material, a foam core with a rubber or plastic coating as a shell on one or more sides, a polymeric foam, a urethane foam, a closed cell foam, a polyurethane foam, a polystyrene, a sculpture foam, a balsa wood, a woven fabric around a block of a stiff material, and any combination thereof.

6. The step navigation assisting apparatus according to claim 1,
wherein the one continuous strap has an elastic portion and a nonelastic portion.

7. The step navigation assisting apparatus according to claim 1,
wherein the height of the top surface of the platform top above the bottom surface of the platform bottom is about one-half of the step change in the elevation to be navigated by the person at a home or a public place.

8. The step navigation assisting apparatus according to claim 1,
wherein the platform is a rectangular platform weighing between about 6 ounces to about 16 ounces,
wherein the platform has a width of between about 5 inches to about 6 inches and the platform has a length of between about 7.5 inches to about 9.5 inches,
wherein the height of the platform top surface above the platform bottom surface is between about 2.5 inches to about 4.5 inches,
wherein the one continuous strap comprises an elastic strap with a strap length of between about 14 inches to about 18 inches long with a strap width of between about ½ inch to about 3 inches wide and a strap thickness of between about 1/16 inch to about ½ inch thick, and
wherein the connector system at the two end portions of the one continuous strap has a fiber mat end portion and a mini-hooks portion.

9. A step navigation assisting apparatus for attaching to just one footwear of two footwear worn on a person during a navigation of a step change in elevation to reduce an amount of knee bending and fatigue of the person during the navigation of the step change in the elevation, the step navigation assisting apparatus comprising:
a platform with a platform bottom surface, a platform top surface, one platform front end, at least two platform side walls, a platform light, and one attachment means,
wherein the platform top surface is for placing the one footwear of the two footwear worn by the person,
wherein the platform has a single horizontal transverse hole running between the two platform side walls in front half of the platform,
wherein the one attachment means is one continuous strap,
wherein the one continuous strap passes through the single horizontal transverse hole between the two platform side walls in the front half of the platform as means to anchor the one continuous strap to the platform,
wherein the one continuous strap has two end portions with a connector system for connecting the two end portions of the one continuous strap together in front of the ankle when the one footwear is placed on the platform top surface so as to attach the one footwear to the platform so the platform and the one footwear can move attached together during the navigation of the step change in the elevation so as to allow both hands of the person to be free for holding onto a safety hand railing if needed by the person during the navigation of the step change in the elevation,
wherein the platform bottom surface is for contacting each step horizontal surface during the navigation of the step change in the elevation by the person,
wherein the platform top surface is at a height above the platform bottom surface,
wherein the height is selected from the group consisting of between about 2 inches to about 2.5 inches, between about 2.5 inches to about 3 inches, between about 3 inches to about 3.5 inches, between about 3.5 inches to about 4 inches, between about 4 inches to about 4.5 inches, between about 4.5 inches to about 5 inches, between about 5 inches to about 5.5 inches, between about 5.5 inches to about 6 inches, between about 6 inches to about 6.5 inches, and between about 6.5 inches to about 7 inches,
wherein the platform attached to the one footwear of the two footwear worn on the person is for keeping the one footwear of the two footwear worn on the person at the height of the platform top surface above the platform bottom surface during the navigation of the step change in the elevation so as to reduce the amount of the knee bending and the fatigue of the person during the navigation of the step change in the elevation by the person,
wherein the attachment of the platform to the one footwear of the two footwear on the person is detachable, and
wherein the platform light is for illumination for the person during the navigation of the step change in the elevation.

10. The step navigation assisting apparatus according to claim 1,
wherein the one continuous strap is one continuous elastic strap, and
wherein the platform has added holes as a means for reducing the platform weight by about 5 percent to about 10 percent, by about 10 percent to about 30 percent, by about 30 percent to about 50 percent, by about 50 percent to about 70 percent, or by about 70 percent to about 90 percent of the weight.

11. The step navigation assisting apparatus according to claim 9,
wherein the platform top surface has a platform top perimeter selected from the group consisting of a rectangular platform top perimeter, a rounded platform top perimeter, a polygonal platform top perimeter, and any combination thereof.

12. The step navigation assisting apparatus according to claim 9,
wherein the platform is made with a material selected from the group consisting of a lightweight foam rubber, a plastic, a dense foamed plastic, an elastic porous material, a foam core with a rubber or plastic coating as a shell on one or more sides, a polymeric foam, a urethane foam, a closed cell foam, a polyurethane foam, a polystyrene, a sculpture foam, a balsa wood, a woven fabric around a block of a stiff material, and any combination thereof.

13. The step navigation assisting apparatus according to claim 1,
wherein the one continuous strap is glued in the single horizontal transverse hole so the one continuous strap does not slide in the single horizontal transverse hole when pulled by the person.

14. The step navigation assisting apparatus according to claim 9,
wherein the platform has a length of between about 7.5 to about 9.5 inches, and
wherein the platform has a footwear pattern pointing to the one platform front end to show where the one footwear is to be placed for attachment to the platform.

15. The step navigation assisting apparatus according to claim 9,
wherein the one continuous strap has two end portions with the connector system for connecting the two end portions of the one continuous strap together over a top section of the one footwear in front of the ankle so as to hold securely the one footwear to the platform,
wherein one of the two end portions of the one continuous strap has a fiber mat end portion and second of the two end portions of the one continuous strap has mini hooks, and
wherein the fiber mat and the mini hooks are capable of connecting the two end portions of the one continuous strap together.

16-20. (canceled)
